(19) United States
(12) Patent Application Publication
(10) Pub. No.: US 2016/0200175 A1
(43) Pub. Date: Jul. 14, 2016

(54) EJECTOR REFRIGERATION CYCLE

(71) Applicant: DENSO CORPORATION, Aichi (JP)

(72) Inventors: Daisuke NAKAJIMA, Kariya-city (JP); Yoshiaki TAKANO, Kariya-city (JP); Haruyuki NISHIJIMA, Kariya-city (JP); Yoshiyuki YOKOYAMA, Kariya-city (JP)

(73) Assignee: DENSO CORPORATION, Kariya-city, Aichi-pref. (JP)

(21) Appl. No.: 14/914,565

(22) PCT Filed: Aug. 6, 2014
(86) PCT No.: PCT/JP2014/004114

§ 371 Date: Feb. 25, 2016

(30) Foreign Application Priority Data
Aug. 29, 2013 (JP) 2013-177738
Jul. 9, 2014 (JP) 2014-141424

(51) Int. Cl. B60H 1/32; F25B 41/06; F25B 43/00; F25B 41/00; B60H 1/00; F25B 5/02

(52) U.S. Cl. CPC B60H 1/323; B60H 1/00021; F25B 5/02; F25B 43/00; F25B 41/00; F25B 41/062; B60H 2001/002

(57) ABSTRACT

An ejector refrigeration cycle includes an upstream-side branch portion for branching a flow of a refrigerant flowing out a radiator, an upstream-side ejector having an upstream-side nozzle for decompressing one of the refrigerants branched by the upstream-side branch portion, and a gas-liquid separator for separating the refrigerant flowing out the upstream-side ejector into gas and liquid phase refrigerants. The liquid-phase refrigerant flowing out of the gas-liquid separator is decompressed by a low-pressure side fixed throttle and allowed to evaporate at a first evaporator. The other refrigerant branched by the upstream-side branch portion is decompressed by a high-pressure side fixed throttle and allowed to evaporate at a second evaporator. A merging portion merges the refrigerant flowing out of the first evaporator with the refrigerant flowing out of the second evaporator, so that the merged refrigerant is sucked from an upstream-side refrigerant suction port of the upstream-side ejector.

### CROSS REFERENCE TO RELATED APPLICATIONS

The application is based on Japanese Patent Applications No. 2013-177738 filed on Aug. 29, 2013, and No. 2014-141424 filed on Jul. 9, 2014, the contents of which are incorporated herein by reference in its entirety.

### TECHNICAL FIELD

The present disclosure relates to an ejector refrigeration cycle including an ejector as a refrigerant decompression device.

### BACKGROUND ART

An ejector refrigeration cycle is conventionally known as a vapor compression refrigeration cycle that includes an ejector as a refrigerant decompression device. For example, Patent Document 1 discloses an ejector refrigeration cycle that includes a branch portion for branching the flow of refrigerant. The branch portion is disposed downstream of a radiator for dissipating heat from a high-pressure refrigerant discharged from a compressor. One refrigerant branched by the branch portion flows out toward a nozzle of the ejector, while the other refrigerant is guided toward a refrigerant suction port of the ejector.

The ejector refrigeration cycle disclosed in Patent Document 1 further includes a first evaporator (outflow side evaporator), a fixed throttle, and a second evaporator (suction side evaporator). The first evaporator is disposed downstream of a pressurizing portion (diffuser) of the ejector to evaporate the refrigerant flowing out of the ejector. The fixed throttle decompresses the refrigerant. The second evaporator evaporates the refrigerant decompressed by the fixed throttle. The fixed throttle and the second evaporator are disposed between the branch portion and the refrigerant suction port of the ejector. Both evaporators are capable of allowing the refrigerant to cool a fluid to be cooled.

In the ejector refrigeration cycle disclosed in Patent Document 1, the refrigerant pressurized at the pressurizing portion of the ejector is allowed to flow into the first evaporator, and the pressure of refrigerant directly after being decompressed by the nozzle of the ejector is applied to the refrigerant outlet side of the second evaporator. Thus, the refrigerant evaporation pressure (refrigerant evaporation temperature) in the second evaporator is set lower than that in the first evaporator.

### PRIOR ART LIST

### Patent Document

Patent Document 1: Japanese Unexamined Patent Application Publication No. 2005-308380

### SUMMARY OF INVENTION

As a result of the consideration of the invention in the present application, in the ejector refrigeration cycle described in Patent Document 1, an injection refrigerant decompressed by the nozzle of the ejector is mixed with a suction refrigerant drawn from the refrigerant suction port of the ejector, and the mixed refrigerant then flows into the first evaporator, whereby the enthalpy of refrigerant flowing into the first evaporator tends to become higher than that of refrigerant flowing into the second evaporator.

Thus, the refrigeration capacity exhibited by the refrigerant in the first evaporator (or a value obtained by subtracting the enthalpy of the refrigerant on the inlet side of the evaporator from the enthalpy of the refrigerant on the outlet side thereof) tends to be smaller than that exhibited by the refrigerant in the second evaporator. Further, the flow rate of refrigerant flowing into the first evaporator (mass flow rate) also tends to differ from that of refrigerant flowing into the second evaporator.

In the general vapor compression refrigeration cycle, the cooling capacity of the evaporator required to cool a fluid to be cooled at a desired flow rate down to a desired temperature is determined depending on the above-mentioned refrigerant evaporation temperature at the evaporator, the refrigeration capacity exhibited by the refrigerant at the evaporator, the flow rate of refrigerant flowing into the evaporator, and the like.

More specifically, as the refrigerant evaporation temperature at the evaporator becomes lower, the cooling capacity is improved. As the refrigeration capacity exhibited by the refrigerant at the evaporator is enhanced, the cooling capacity is also improved. Furthermore, as the flow rate of refrigerant flowing into the evaporator is increased, the cooling capacity of the evaporator is improved.

Therefore, in the ejector refrigeration cycle disclosed in Patent Document 1, the cooling capacity at the first evaporator might possibly differ from that at the second evaporator. Further, if the cooling capacity of the first evaporator significantly differs from that of the second evaporator, the temperature of fluids to be cooled at the respective evaporators might become non-uniform when cooling different fluids to be cooled with the respective evaporators.

Supposing that the ejector refrigeration cycle disclosed in Patent Document 1 is applied to a vehicle air conditioner of a dual air conditioner type to use one evaporator for cooling a front-seat side ventilation air to be blown to the front seat side of the vehicle and to use the other evaporator for cooling a rear-seat side ventilation air to be blown to the rear seat side thereof, the temperature of the front-seat side ventilation air and the temperature of the rear-seat side ventilation air might not be uniform.

The present disclosure has been made in view of the foregoing matter, and it is an object of the present disclosure to provide an ejector refrigeration cycle with a plurality of evaporators, in which the cooling capacity for the fluid to be cooled can be approached each other in the evaporators.

To achieve the above object of the present disclosure, an ejector refrigeration cycle according to a first aspect of the present disclosure includes: a compressor adapted to compress and discharge a refrigerant; a radiator that dissipates heat from the refrigerant discharged from the compressor; an upstream-side branch portion that branches a flow of the refrigerant flowing out of the radiator; an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the upstream-side branch portion, the upstream-side ejector being adapted to cause an upstream-side pressurizing portion to pressurize a mixed refrigerant of the upstream-side injection refrigerant and the refrigerant drawn from the upstream-side refrigerant suction port; a low-pressure side gas-liquid separator that separates the refrigerant flowing out of the upstream-side ejector into gas and liquid phase refrigerants, to allow the separated gas-phase refrigerant to flow to a suction port side of the compressor; a first evaporator that evaporates the liquid-phase refrigerant separated by the low-pressure side gas-liquid separator; a decompression device that decompresses the other refrigerant branched by the upstream-side branch portion; and a second evaporator that evaporates the refrigerant decompressed by the decompression device. Furthermore, the upstream-side refrigerant suction port of the upstream-side ejector is coupled to at least a refrigerant outlet side of the first evaporator.

The liquid-phase refrigerant separated by the low-pressure side gas-liquid separator flows into the first evaporator, thereby allowing the refrigerant having a relatively low enthalpy to flow into the first evaporator. Further, because the refrigerant flowing out of the radiator and decompressed by the decompression device flows into the second evaporator, the refrigerant having a relatively low enthalpy can flow into the second evaporator.

Therefore, a difference in enthalpy between the refrigerant flowing into the first evaporator and the refrigerant flowing into the second evaporator can be reduced, making the refrigeration capacity exhibited by the refrigerant at the first evaporator close to that at the second evaporator. As a result, the cooling capacity of the first evaporator can be made close to that of the second evaporator.

An ejector refrigeration cycle according to a second aspect of the present disclosure includes: a compressor adapted to compress and discharge a refrigerant; a radiator that dissipates heat from the refrigerant discharged from the compressor; an upstream-side branch portion that branches a flow of the refrigerant flowing out of the radiator; an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the upstream-side branch portion, the upstream-side ejector being adapted to cause an upstream-side pressurizing portion to pressurize a mixed refrigerant including the upstream-side injection refrigerant and the refrigerant drawn from the upstream-side refrigerant suction port; a downstream-side branch portion that branches a flow of the refrigerant flowing out of the upstream-side ejector; a downstream-side ejector that draws a refrigerant from a downstream-side refrigerant suction port by a suction effect of a downstream-side injection refrigerant injected at high velocity from a downstream-side nozzle adapted to decompress one of the refrigerants branched by the downstream-side branch portion, the downstream-side ejector being adapted to cause a downstream-side pressurizing portion to pressurize a mixed refrigerant of the downstream-side injection refrigerant and the refrigerant drawn from the downstream-side refrigerant suction port; a first evaporator that evaporates the other refrigerant branched by the downstream-side branch portion; a decompression device that decompresses the other refrigerant branched by the upstream-side branch portion; and a second evaporator that evaporates the refrigerant decompressed by the decompression device. In addition, the upstream-side refrigerant suction port is coupled to a refrigerant outlet side of the first evaporator, and the downstream-side refrigerant suction port is coupled to a refrigerant outlet side of the second evaporator.

The refrigerant outlet side of the second evaporator is coupled to the downstream-side refrigerant suction port of the downstream-side ejector, whereby the refrigerant evaporation pressure at the second evaporator can be reduced, compared to that of the refrigerant flowing out of the downstream-side pressurizing portion.

Therefore, the refrigerant evaporation pressure (refrigerant evaporation temperature) at the second evaporator can be reduced to approach the refrigerant evaporation pressure (refrigerant evaporation temperature) at the first evaporator. As a result, the cooling capacity of the first evaporator can be made close to that of the second evaporator.

An ejector refrigeration cycle according to a third aspect of the present disclosure includes: a compressor adapted to compress and discharge a refrigerant; a radiator that dissipates heat from the refrigerant discharged from the compressor; an upstream-side branch portion that branches a flow of the refrigerant flowing out of the radiator; an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the upstream-side branch portion, the upstream-side ejector being adapted to cause an upstream-side pressurizing portion to pressurize a mixed refrigerant of the upstream-side injection refrigerant and the refrigerant drawn from the upstream-side refrigerant suction port; an upstream-side gas-liquid separator that separates the refrigerant flowing out of the upstream-side ejector into gas and liquid phase refrigerants, to allow the separated gas-phase refrigerant to flow out to a suction port side of the compressor; a first evaporator that evaporates the liquid-phase refrigerant separated by the upstream-side gas-liquid separator, to allow the refrigerant to flow out toward the upstream-side refrigerant suction port; a downstream-side ejector that draws a refrigerant from a downstream-side refrigerant suction port by a suction effect of a downstream-side injection refrigerant injected at high velocity from a downstream-side nozzle adapted to decompress the other refrigerant branched by the upstream-side branch portion, the downstream-side ejector being adapted to cause a downstream-side pressurizing portion to pressurize a mixed refrigerant of the downstream-side injection refrigerant and a refrigerant drawn from the downstream-side refrigerant suction port; a downstream-side gas-liquid separator that separates the refrigerant flowing out of the downstream-side ejector into gas and liquid phase refrigerants, to allow the separated gas-phase refrigerant to flow out to the suction port side of the compressor; and a second evaporator that evaporates the liquid-phase refrigerant separated by the downstream-side gas-liquid separator to allow the refrigerant to flow out toward the downstream-side refrigerant suction port.

The refrigerant flowing into the first evaporator and the refrigerant flowing into the second evaporator can be respectively decompressed by different decompression devices, whereby the refrigerant evaporation temperature at the first evaporator can be easily set substantially equal to that at the second evaporator. Likewise, the flow rate of refrigerant flowing into the first evaporator can be easily set substantially equal to that into the second evaporator.

Further, the refrigeration cycle is configured to allow the liquid-phase refrigerant separated by the upstream-side gas-liquid separator to flow into the first evaporator, and to allow the liquid-phase refrigerant separated by the downstream-side gas-liquid separator to flow into the second evaporator, whereby the refrigeration capacity exhibited by the refrigerant at the first evaporator can be easily set close to that at the second evaporator.

As a result, the cooling capacity of the first evaporator can be effectively made close to that of the second evaporator.

An ejector refrigeration cycle according to a fourth aspect of the present disclosure includes: a compressor adapted to compress and discharge a refrigerant; a radiator that dissipates heat from the refrigerant discharged from the compressor; a first upstream-side branch portion that branches a flow of the refrigerant flowing out of the radiator; an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the first upstream-side branch portion, the upstream-side ejector being adapted to cause an upstream-side pressurizing portion to pressurize a mixed refrigerant of the upstream-side injection refrigerant and the refrigerant drawn from the upstream-side refrigerant suction port; a gas-liquid separator that separates the refrigerant flowing out of the upstream-side ejector into gas and liquid phase refrigerants, to allow the separated gas-phase refrigerant to flow out to a suction port side of the compressor; a first evaporator that evaporates the liquid-phase refrigerant separated by the gas-liquid separator to allow the refrigerant to flow out toward the upstream-side refrigerant suction port; a second upstream-side branch portion that further branches a flow of the other refrigerant branched by the first upstream-side branch portion; a downstream-side ejector that draws a refrigerant from a downstream-side refrigerant suction port by a suction effect of a downstream-side injection refrigerant injected at high velocity from a downstream-side nozzle adapted to decompress one of the refrigerants branched by the second upstream-side branch portion, the downstream-side ejector being adapted to cause a downstream-side pressurizing portion to pressurize a mixed refrigerant of the downstream-side injection refrigerant and the refrigerant drawn from the downstream-side refrigerant suction port; a decompression device that decompresses the other refrigerant branched by the second upstream-side branch portion; and a second evaporator that evaporates the refrigerant decompressed by the decompression device to allow the refrigerant to flow out toward the downstream-side refrigerant suction port; a merging portion that merges a flow of the gas-phase refrigerant separated by the low-pressure side gas-liquid separator with a flow of the refrigerant flowing out of the downstream-side pressurizing portion to allow the merged refrigerant to flow out toward a suction side of the compressor; and an internal heat exchanger that exchanges heat between a high-pressure refrigerant circulating through a refrigerant flow path leading from a refrigerant outlet side of the radiator to an inlet side of the first upstream-side branch portion and a low-pressure refrigerant circulating through a refrigerant flow path leading from an outlet side of the downstream-side pressurizing portion to a suction port side of the compressor.

Because the refrigerant flowing into the first evaporator and the refrigerant flowing into the second evaporator can be respectively decompressed by different decompression devices, the refrigerant evaporation temperature at the first evaporator can be easily set substantially equal to that at the second evaporator. Likewise, the flow rate of refrigerant flowing into the first evaporator can be easily set substantially equal to that into the second evaporator.

As a result, the cooling capacity of the first evaporator can be effectively made close to that of the second evaporator.

Further, the low-pressure refrigerant flowing into the internal heat exchanger can be brought into the gas-liquid two-phase state, which can prevent the unnecessary increase in superheat degree of the refrigerant flowing out of the internal heat exchanger and drawn into the compressor. Thus, the refrigerant discharged from the compressor can be prevented from excessively being at high temperature and from adversely affecting the durability life of the compressor.

### BRIEF DESCRIPTION OF DRAWINGS

FIG. 1 is a schematic entire configuration diagram showing an ejector refrigeration cycle in a first embodiment.

FIG. 2 is a cross-sectional view in an axial direction of an ejector in the first embodiment.

FIG. 3 is a Mollier diagram showing the state of refrigerant in the ejector refrigeration cycle of the first embodiment.

FIG. 4 is a schematic entire configuration diagram showing an ejector refrigeration cycle in a second embodiment.

FIG. 5 is a Mollier diagram showing the state of refrigerant in the ejector refrigeration cycle of the second embodiment.

FIG. 6 is a schematic entire configuration diagram showing an ejector refrigeration cycle in a third embodiment.

FIG. 7 is a Mollier diagram showing the state of refrigerant in the ejector refrigeration cycle of the third embodiment.

FIG. 8 is a schematic entire configuration diagram showing an ejector refrigeration cycle in a fourth embodiment.

FIG. 9 is a schematic entire configuration diagram showing an ejector refrigeration cycle in a fifth embodiment.

FIG. 10 is a Mollier diagram showing the state of refrigerant in the ejector refrigeration cycle of the fifth embodiment.

FIG. 11 is a schematic entire configuration diagram showing an ejector refrigeration cycle in a sixth embodiment.

FIG. 12 is a schematic entire configuration diagram showing an ejector refrigeration cycle in a seventh embodiment.

FIG. 13 is a schematic entire configuration diagram showing an ejector refrigeration cycle in an eighth embodiment.

FIG. 14 is a schematic entire configuration diagram showing an ejector refrigeration cycle in a ninth embodiment.

FIG. 15 is a schematic entire configuration diagram showing an ejector refrigeration cycle in a tenth embodiment.

FIG. 16 is a schematic entire configuration diagram showing an ejector refrigeration cycle in an eleventh embodiment.

FIG. 17 is a schematic entire configuration diagram showing an ejector refrigeration cycle in a twelfth embodiment.

FIG. 18 is a Mollier diagram showing the state of refrigerant in the ejector refrigeration cycle of the twelfth embodiment.

FIG. 19 is a schematic entire configuration diagram showing an ejector refrigeration cycle in a thirteenth embodiment.

FIG. 20 is a schematic entire configuration diagram showing an ejector refrigeration cycle in a fourteenth embodiment.

FIG. 21 is a schematic entire configuration diagram showing an ejector refrigeration cycle in a fifteenth embodiment.

FIG. 22 is a schematic entire configuration diagram showing an ejector refrigeration cycle in a sixteenth embodiment.

FIG. 23 is a schematic entire configuration diagram showing an ejector refrigeration cycle in a seventeenth embodiment.

FIG. 24 is a schematic entire configuration diagram showing an ejector refrigeration cycle in an eighteenth embodiment.

FIG. 25 is a schematic entire configuration diagram showing an ejector refrigeration cycle in a nineteenth embodiment.

FIG. 26 is a schematic entire configuration diagram showing an ejector refrigeration cycle in a twentieth embodiment.

FIG. 27 is a schematic entire configuration diagram showing an ejector refrigeration cycle in a twenty-first embodiment.

FIG. 28 is a schematic entire configuration diagram showing an ejector refrigeration cycle in a twenty-second embodiment.

FIG. 29 is a schematic entire configuration diagram showing an ejector refrigeration cycle in a twenty-third embodiment.

FIG. 30 is a schematic entire configuration diagram showing an ejector refrigeration cycle in a twenty-fourth embodiment.

FIG. 31 is a schematic entire configuration diagram showing an ejector refrigeration cycle in a twenty-fifth embodiment.

FIG. 32 is a schematic entire configuration diagram showing an ejector refrigeration cycle in a twenty-sixth embodiment.

FIG. 33 is a Mollier diagram showing the state of refrigerant in the ejector refrigeration cycle of the twenty-sixth embodiment.

### DESCRIPTION OF EMBODIMENTS

### First Embodiment

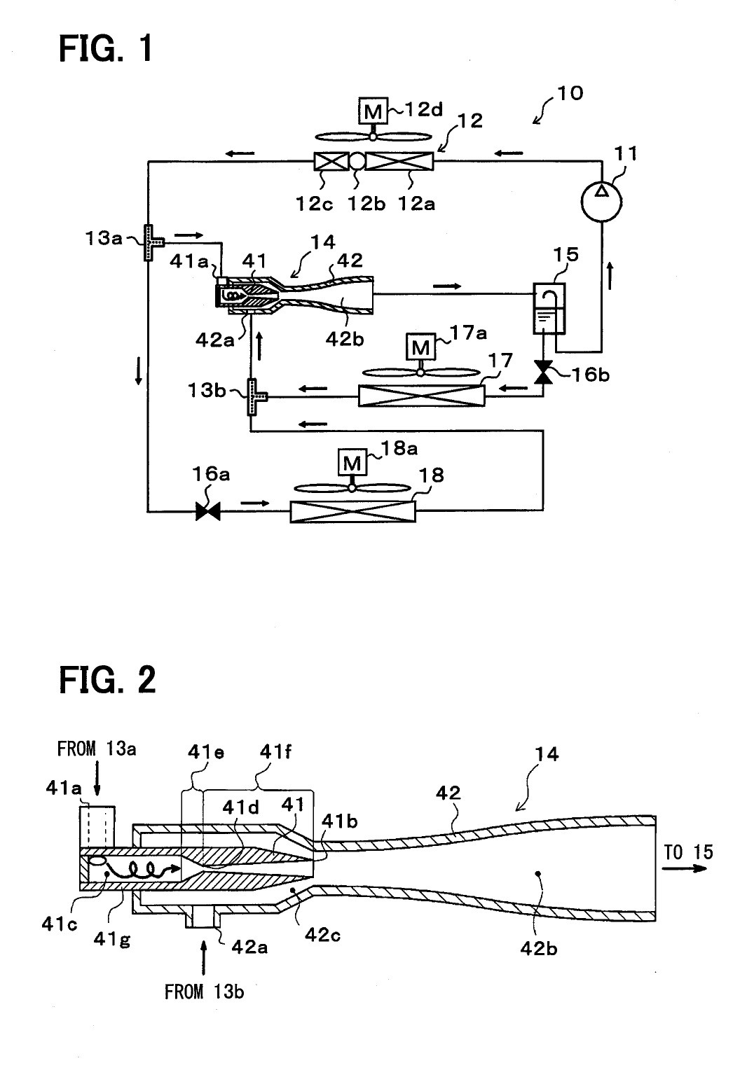

A first embodiment of the present disclosure will be described below with reference to FIGS. 1 to 3. An ejector refrigeration cycle 10 in this embodiment is applied to a vehicle air conditioner of a dual air conditioner type and serves to cool ventilation air to be blown into the vehicle interior as a space to be air-conditioned.

The vehicle air conditioner of the dual air conditioner type includes a front-seat air conditioning unit for blowing conditioned air mainly to a region on the front seat side in a vehicle compartment, and a rear-seat air conditioning unit for blowing conditioned air mainly to a region on the rear seat side. In the ejector refrigeration cycle 10, a first evaporator 17 and a second evaporator 18 for evaporating the low-pressure refrigerant are disposed in ventilation-air passages formed in the respective units.

In this embodiment, both the front-seat side ventilation air to be blown toward the front seat side of the vehicle compartment and the rear-seat side ventilation air to be blown toward the rear seat side thereof act as fluids to be cooled at the ejector refrigeration cycle 10.

The ejector refrigeration cycle 10 employs a hydrofluorocarbon (HFC) refrigerant (e.g., R134a) as the refrigerant, and forms a subcritical refrigeration cycle that has its high-pressure side refrigerant pressure not exceeding the critical pressure of the refrigerant. Obviously, a hydrofluoro-olefin (HFO) refrigerant (for example, R1234yf) or the like may be used as the refrigerant. Further, refrigerating machine oil for lubricating a compressor 11 is mixed into the refrigerant, and a part of the refrigerating machine oil circulates through the cycle together with the refrigerant.

Next, the detailed structure of the ejector refrigeration cycle 10 will be described below. In the ejector refrigeration cycle 10 shown in the entire configuration diagram of FIG. 1, the compressor 11 draws the refrigerant, pressurizes the drawn refrigerant to a high-pressure refrigerant, and then discharges the pressurized refrigerant therefrom. Specifically, the compressor 11 of this embodiment is an electric compressor that accommodates, in one housing, a fixed displacement compression mechanism and an electric motor for driving the compression mechanism.

Various types of compression mechanisms, including a scroll compression mechanism and a vane compression mechanism, can be employed as the compression mechanism. The electric motor has its operation (the number of revolutions) controlled by a control signal output from a controller to be described later. The electric motor may employ either an AC motor or a DC motor.

Further, the compressor 11 may be an engine-driven compressor that is driven by a rotational driving force transferred from the engine for vehicle traveling via a pulley, a belt, etc., This kind of engine-driven compressor suitable for use can be, for example, a variable displacement compressor that is capable of adjusting the refrigerant discharge capacity by changing the displaced volume thereof, a fixed displacement compressor that is capable of adjusting the refrigerant discharge capacity by changing an operating rate of the compressor through connection/disconnection of an electromagnetic clutch, or the like.

A discharge port side of the compressor 11 is coupled to a refrigerant inlet side of a condensing portion 12a of a radiator 12. The radiator 12 is a heat-radiation heat exchanger that exchanges heat between a high-pressure refrigerant discharged from the compressor 11 and the air outside the vehicle compartment (outside air) blown from a cooling fan 12d, thereby dissipating heat from the high-pressure refrigerant to cool the refrigerant.

More specifically, the radiator 12 is the so-called subcool condenser that includes the condensing portion 12a, a receiver 12b, and a supercooling portion 12c. The condensing portion 12a condenses the high-pressure gas-phase refrigerant discharged from the compressor 11 by exchanging heat between the high-pressure gas-phase refrigerant and the outside air blown from the cooling fan 12d to dissipate heat from the refrigerant. The receiver 12b serving as a high-pressure side gas-liquid separator that separates the refrigerant flowing out of the condensing portion 12a into gas and liquid phase refrigerants to store therein the excessive liquid-phase refrigerant. The supercooling portion 12c supercools the liquid-phase refrigerant by exchanging heat between the liquid-phase refrigerant flowing out of the receiver 12b and the outside air blown from the cooling fan 12d.

The cooling fan 12d is an electric blower having the number of revolutions (volume of ventilation air) controlled by a control voltage output from the controller.

The refrigerant outlet side of the supercooling portion 12c in the radiator 12 is coupled to a refrigerant inflow port of an upstream-side branch portion 13a that branches the flow of refrigerant flowing out of the radiator 12. The upstream-side branch portion 13a is configured of a three-way joint that has three inflow/outflow ports, one of which is the refrigerant inflow port, and the remaining two of which are refrigerant outflow ports. Such a three-way joint may be formed by jointing pipes with different diameters, or by providing a plurality of refrigerant passages in a metal or resin block.

One of the refrigerant outflow ports of the upstream-side branch portion 13a is coupled to a refrigerant inflow port 41a of an upstream-side nozzle 41 in an upstream-side ejector 14. The other of the refrigerant outflow ports of the upstream-side branch portion 13a is coupled to an upstream-side refrigerant suction port 42a formed in an upstream-side body 42 of the upstream-side ejector 14 via a high-pressure side fixed throttle 16a and the second evaporator 18 to be described later.

The upstream-side ejector 14 serves as a decompression device for decompressing the high-pressure refrigerant flowing out of the radiator 12, while serving as a refrigerant circulation portion (refrigerant transport portion) that draws (transports) the refrigerant by a suction effect of the refrigerant injected from the upstream-side nozzle 41 at a high velocity to allow the refrigerant to circulate through the cycle.

The detailed structure of the upstream-side ejector 14 will be described below using FIG. 2. As shown in FIG. 2, the upstream-side ejector 14 includes the upstream-side nozzle 41 and the upstream-side body 42. The upstream-side nozzle 41 is formed of metal (e.g., a stainless alloy) and has a substantially cylindrical shape that gradually tapered toward the flow direction of the refrigerant. The upstream-side nozzle 41 isentropically decompresses the refrigerant flowing thereinto to inject the decompressed refrigerant from the refrigerant injection port 41b provided on the most downstream-side of the refrigerant flow.

Inside the upstream-side nozzle 41, there are provided a swirling space 41c that swirls the refrigerant flowing thereinto through the refrigerant inflow port 41a, as well as a refrigerant passage that decompresses the refrigerant flowing out of the swirling space 41c.

The refrigerant passage is provided with a minimum passage area portion 41d having the minimum refrigerant passage area, a tapered portion 41e having the refrigerant passage area gradually decreasing from the swirling space 41c toward the minimum passage area portion 41d, and an expanding portion 41f having the refrigerant passage area gradually increasing from the minimum passage area portion 41d toward the refrigerant injection port 41b.

The swirling space 41c is provided on the most upstream side of the refrigerant flow in the upstream-side nozzle 41. The swirling space 41c is a cylindrical space formed inside a cylindrical portion 41g that extends coaxially with the axial direction of the upstream-side nozzle 41. The refrigerant inflow passage that connects the refrigerant inflow port 41a with the swirling space 41c extends in the direction of a tangential line to the inner wall surface of the swirling space 41c as viewed from the central axial direction of the swirling space 41c.

In this way, the refrigerant entering the swirling space 41c through the refrigerant inflow port 41a flows along the inner wall surface of the swirling space 41c and swirls around the central axis of the swirling space 41c. Thus, the cylindrical portion 41g configures a swirling-flow generating portion. In this embodiment, the swirling-flow generating portion and the upstream-side nozzle are integrally formed.

Here, a centrifugal force acts on the refrigerant swirling in the swirling space 41c, whereby the refrigerant pressure on the central shaft side of the swirling space 41c becomes lower than that on the outer peripheral side thereof. In this embodiment, during the normal operation of the ejector refrigeration cycle 10, the refrigerant pressure on the central axis side within the swirling space 41c is decreased to a pressure that generates a saturated liquid-phase refrigerant, or a pressure that causes the refrigerant to be decompressed and boiled (causing cavitation).

The refrigerant pressure on the central shaft side of the swirling space 41c can be controlled by adjusting the swirling flow velocity of the refrigerant swirling within the swirling space 41c. Further, the swirling flow velocity can be adjusted or controlled, for example, by adjusting the ratio of the passage sectional area of the refrigerant inflow passage to the vertical sectional area in the axial direction of the swirling space 41c. Note that the term “swirling flow velocity” as used in this embodiment means the flow velocity in the swirling direction of the refrigerant in the vicinity of the outermost periphery of the swirling space 41c.

The tapered portion 41e is disposed coaxially with the swirling space 41c and formed in a truncated cone shape that gradually decreases its refrigerant passage area from the swirling space 41c toward the minimum passage area portion 41d. The expanding portion 41f is disposed coaxially with the swirling space 41c and the tapered portion 41e and formed in a truncated cone shape that gradually increases its refrigerant passage area from the minimum passage area portion 41d toward the refrigerant injection port 41b.

The upstream-side body 42 is formed of metal (e.g., aluminum) having a substantially cylindrical shape. The body 42 acts as a fixing member that supports and fixes the upstream-side nozzle 41 to the inside thereof and forms an outer shell of the upstream-side ejector 14. More specifically, the upstream-side nozzle 41 is fixed by being press-fitted or the like into the upstream-side body 42 to be accommodated in a part of the upstream-side body 42 on one end side in the longitudinal direction thereof.

An upstream-side refrigerant suction port 42a is formed to penetrate the part of the outer peripheral side surface of the upstream-side body 42 corresponding to the outer periphery side of the upstream-side nozzle 41 so as to communicate with the refrigerant injection port 41b of the upstream-side nozzle 41. The upstream-side refrigerant suction port 42a is a through hole that draws the refrigerant flowing out of the second evaporator 18 into the upstream-side ejector 14 by a suction effect of the injection refrigerant injected from the refrigerant injection port 41b of the upstream-side nozzle 41.

Thus, an inlet space for inflow of the refrigerant is formed around the upstream-side refrigerant suction port 42a inside the upstream-side body 42. A suction passage 42c is formed between the outer peripheral wall surface surrounding the tip end of the tapered upstream-side nozzle 41 and the inner peripheral wall surface of the upstream-side body 42. The suction passage 42c is formed to guide the sucked refrigerant flowing into the upstream-side body 42 toward an upstream-side diffuser 42b.

The refrigerant passage area of the suction passage 42c gradually reduces toward the refrigerant flow direction. Thus, in the upstream-side ejector 14 of this embodiment, the flow velocity of the sucked refrigerant circulating through the suction passage 42c is gradually increased, which decreases the energy loss (mixing loss) when mixing the suction refrigerant with the injection refrigerant at the upstream-side diffuser 42b.

The upstream-side diffuser 42b continuously leads to an outlet side of the suction passage 42c and is formed such that the refrigerant passage area is gradually increased. Thus, the diffuser exhibits a function of converting, to the pressure energy, the kinetic energy of the mixed refrigerant including the injection refrigerant and the suction refrigerant. That is, the diffuser acts as an upstream-side pressurizing portion that pressurizes the mixed refrigerant by decelerating the flow velocity of the mixed refrigerant.

More specifically, the shape of the inner peripheral wall surface of the upstream-side body 42 forming the upstream-side diffuser 42b in this embodiment is formed by a combination of a plurality of curved lines as illustrated in the axial-directional sectional view of FIG. 2. The expanding degree of the refrigerant passage sectional area of the upstream-side diffuser 42b is gradually increased and then decreased again along the refrigerant flow direction, which can isentropically raise the pressure of the refrigerant.

As shown in FIG. 1, the refrigerant outlet side of the upstream-side ejector 14 is coupled to the refrigerant inflow port of a gas-liquid separator 15. The gas-liquid separator 15 is a low-pressure side gas-liquid separator that separates the refrigerant flowing thereinto, into liquid and gas refrigerants. Further, this embodiment employs the gas-liquid separator 15 that allows the separated liquid-phase refrigerant to flow out of the liquid-phase refrigerant outflow port almost without storing the separated liquid-phase refrigerant. Alternatively, the gas-liquid separator 15 may be one serving as a liquid reservoir for storing therein excessive liquid-phase refrigerant in the cycle.

A gas-phase refrigerant outflow port of the gas-liquid separator 15 is coupled to a suction side of the compressor 11. On the other hand, the liquid-phase refrigerant outflow port of the gas-liquid separator 15 is coupled to the refrigerant inlet side of the first evaporator 17 via a low-pressure side fixed throttle 16b as the decompression device. The low-pressure side fixed throttle 16b is a decompression device that decompresses the liquid-phase refrigerant flowing out of the gas-liquid separator 15. Specifically, the fixed throttle suitable for use can include an orifice, a capillary tube, a nozzle, and the like.

The first evaporator 17 is a heat exchanger for heat absorption that exchanges heat between a low-pressure refrigerant decompressed by the upstream-side ejector 14 and the low-pressure side fixed throttle 16b and the front-seat side ventilation air to be blown from the blower fan 17a toward the front seat side of the vehicle compartment, thereby exhibiting a heat absorption effect through evaporation of the low-pressure refrigerant. The blower fan 17a is an electric blower having the number of revolutions (volume of ventilation air) controlled by a control voltage output from the controller.

The refrigerant outlet side of the first evaporator 17 is coupled to one refrigerant inflow port of a merging portion 13b. The merging portion 13b is formed of the same type of three-way joint as the upstream-side branch portion 13a. The three-way joint has three inflow and outflow ports, two of which are refrigerant inflow ports, and the remaining one of which is a refrigerant outflow port. The other refrigerant inflow port of the merging portion 13b is coupled to the refrigerant outlet side of the second evaporator 18. The refrigerant outflow port of the merging portion 13b is coupled to the upstream-side refrigerant suction port 42a of the upstream-side ejector 14.

The other refrigerant outflow port of the upstream-side branch portion 13a is coupled to the high-pressure side fixed throttle 16a that serves as a decompression device for decompressing the other refrigerant branched by the upstream-side branch portion 13a. The high-pressure side fixed throttle 16a can employ, for example, an orifice, a capillary tube, a nozzle, and the like, like the low-pressure side fixed throttle 16b.

The downstream-side of the refrigerant flow of the high-pressure side fixed throttle 16a is coupled to the refrigerant inlet side of the second evaporator 18. The second evaporator 18 is a heat exchanger for heat absorption that exchanges heat between a low-pressure refrigerant decompressed by the high-pressure side fixed throttle 16a and the rear-seat side ventilation air to be blown from the blower fan 18a toward the rear seat side of the vehicle compartment, thereby exhibiting a heat absorption effect through evaporation of the low-pressure refrigerant.

The refrigerant outlet side of the second evaporator 18 is coupled to the other refrigerant inflow port of the merging portion 13b. The blower fan 18a is an electric blower having the number of revolutions (volume of ventilation air) controlled by a control voltage output from the controller.

The controller (not shown) includes a well-known microcomputer, including a CPU, a ROM, a RAM, and the like, and its peripheral circuit. The controller performs various computations and processing based on control programs stored in the ROM, and controls the operations of the above-mentioned various electric actuators 11, 12d, 17a, 18a, and the like.

A group of sensors for air-conditioning control is connected to the controller. Detection values from these sensors of the sensor group are input to the controller. The group of sensors includes an inside air temperature sensor, an outside air temperature sensor, a solar radiation sensor, first and second evaporator temperature sensors, an outlet side temperature sensor, and an outlet side pressure sensor. The inside air temperature sensor detects the temperature of the vehicle interior. The outside air temperature sensor detects the outside air temperature. The solar radiation sensor detects the solar radiation amount in the vehicle interior. The first and second evaporator temperature sensors detect the blown air temperatures (evaporator temperatures) at the first and second evaporators 17 and 18, respectively. The outlet side temperature sensor detects the temperature of the refrigerant on the outlet side of the radiator 12. The outlet side pressure sensor detects the pressure of the refrigerant on the outlet side of the radiator 12.

An operation panel (not shown) is disposed near an instrument board at the front of the vehicle compartment, and coupled to the input side of the controller. Operation signals are input to the controller from various types of operation switches provided on the operation panel. Various operation switches provided on the operation panel include an air-conditioning operation switch for requesting air conditioning of a vehicle interior, a vehicle interior temperature setting switch for setting a vehicle interior temperature, and the like.

The controller of this embodiment is integrally structured with a control unit for controlling each of various devices to be controlled that are connected to the output side of the controller. In the controller, a structure (hardware and software) adapted to control the operation of each of the devices to be controlled configures the control unit for each of the devices to be controlled. For example, in this embodiment, the structure (hardware and software) that controls the operation of the compressor 11 configures a discharge capacity control unit.

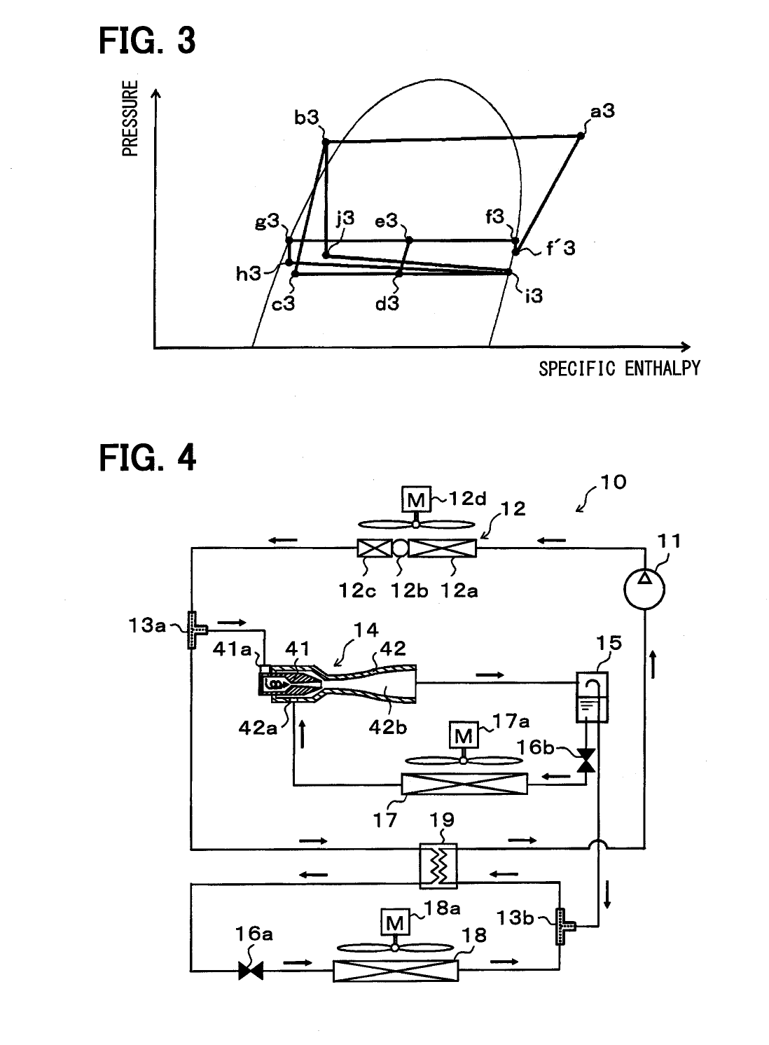

Next, the operation of the above-mentioned structure according to this embodiment will be described with reference to the Mollier diagram of FIG. 3. When an air-conditioning operation switch on the operation panel is turned on (ON), the controller operates the compressor 11, the cooling fan 12d, the blower fans 17a and 18a, and the like. Thus, the compressor 11 sucks, compresses, and discharges the refrigerant.

A high-temperature, high-pressure refrigerant discharged from the compressor 11 (as indicated by a point a3 in FIG. 3) flows into the condensing portion 12a of the radiator 12, and exchanges heat with the outside air blown from the cooling fan 12d, thereby dissipating heat therefrom to be condensed. The refrigerant dissipating heat at the condensing portion 12a is separated into gas and liquid phases at the receiver 12b. The liquid-phase refrigerant separated at the receiver 12b exchanges heat with the outside air blown from the cooling fan 12d at the supercooling portion 12c, further dissipating heat to be converted into a supercooled liquid-phase refrigerant (as indicated from the point a3 to a point b3 in FIG. 3).

The flow of the supercooled liquid-phase refrigerant flowing out of the supercooling portion 12c of the radiator 12 is branched by the upstream-side branch portion 13a. One refrigerant branched at the upstream-side branch portion 13a flows into the refrigerant inflow port 41a of the upstream-side nozzle 41 in the upstream-side ejector 14, and is then isentropically decompressed to be injected from the refrigerant injection port 41b (as indicated from the point b3 to a point c3 in FIG. 3).

The refrigerants flowing out of the first and second evaporators 17 and 18 are drawn into the upstream-side refrigerant suction port 42a via the merging portion 13b by a suction effect of the injection refrigerant on the upstream-side that is injected from the refrigerant injection port 41b. The upstream-side injection refrigerant and the upstream-side suction refrigerant drawn through the upstream-side refrigerant suction port 42a flows into the upstream-side diffuser 42b (as indicated from the point c3 to a point d3, and from a point i3 to the point d3 in FIG. 3).

The upstream-side diffuser 42b converts the kinetic energy of the refrigerant into the pressure energy thereof by increasing the refrigerant passage area. Thus, the pressure of the mixed refrigerant is increased, while mixing the upstream-side injection refrigerant and the upstream-side suction refrigerant (as indicated from the point d3 to a point e3 in FIG. 3). The refrigerant flowing out of the upstream-side diffuser 42b flows into the gas-liquid separator 15 to be separated into gas and liquid phase refrigerants (as indicated from the point e3 to a point f3, and from the point e3 to a point g3 in FIG. 3, respectively).

The gas-phase refrigerant separated by the gas-liquid separator 15 is drawn into the suction port of the compressor 11 and compressed again by the compressor 11 (as indicated from the point f3′ to the point a3 in FIG. 3). Note that the reason why the points f3 and f3′ differ from each other as shown in FIG. 3 is that the gas-phase refrigerant flowing out of the gas-liquid separator 15 causes pressure loss when circulating through the refrigerant pipe leading from the gas-phase refrigerant outflow port of the gas-liquid separator 15 to the suction port of the compressor 11. Therefore, in the ideal cycle, desirably, the point f3 matches with the point f3′. The same goes for other Mollier charts below.

The liquid-phase refrigerant separated by the gas-liquid separator 15 is isentropically decompressed by the low-pressure side fixed throttle 16b (as indicated from the point g3 to a point h3 in FIG. 3) to flow into the first evaporator 17. The refrigerant flowing into the first evaporator 17 absorbs heat from the front-seat side ventilation air blown from the blower fan 17a to evaporate itself. In this way, the front-seat side ventilation air is cooled. Further, the refrigerant leaving the first evaporator 17 flows into the merging portion 13b (as indicated from the point h3 to a point i3 in FIG. 3).

On the other hand, the other refrigerant branched by the upstream-side branch portion 13a flows into the high-pressure side fixed throttle 16a to be isentropically decompressed and expanded (as indicated from the point b3 to a point j3 in FIG. 3), and then flows into the second evaporator 18. The refrigerant flowing into the second evaporator 18 absorbs heat from the rear-seat side ventilation air blown from the blower fan 18a to evaporate itself. In this way, the rear-seat side ventilation air is cooled. Further, the refrigerant leaving the second evaporator 18 flows into the merging portion 13b (as indicated from the point j3 to the point i3 in FIG. 3).

In this embodiment, during the normal operation of the ejector refrigeration cycle 10, the decompression characteristics (flow rate coefficients) of the high-pressure side fixed throttle 16a and the low-pressure side fixed throttle 16b are determined such that the pressure of refrigerant flowing into the first evaporator 17 becomes substantially equal to that of refrigerant flowing into the second evaporator 18. The refrigerant flowing out of the merging portion 13b is drawn from the upstream-side refrigerant suction port 42a of the upstream-side ejector 14, as mentioned above.

The ejector refrigeration cycle 10 of this embodiment operates in the manner described above and thus can cool the front-seat side ventilation air as well as the rear-seat side ventilation air. In the ejector refrigeration cycle 10, the refrigerant pressurized by the upstream-side diffuser 42b in the upstream-side ejector 14 is drawn into the compressor 11, which can decrease the driving power of the compressor 11, thereby improving a coefficient of performance (COP) of the cycle.

Further, in the ejector refrigeration cycle 10 of this embodiment, the liquid-phase refrigerant separated by the gas-liquid separator 15, which serves to separate the refrigerant into gas and liquid phases, is allowed to flow toward the first evaporator 17, so that the refrigerant having a relatively low enthalpy can flow into the first evaporator 17 as indicated by the point h3 in FIG. 3. The refrigerant leaving the radiator 12 is isentropically decompressed by the high-pressure side fixed throttle 16a and then flows into the second evaporator 18, so that the refrigerant having a relatively low enthalpy can flow into the second evaporator 18 as indicated by the point j3 in FIG. 3.

Thus, a difference in enthalpy between the refrigerant flowing into the first evaporator 17 and the refrigerant flowing into the second evaporator 18 can be reduced, making the refrigeration capacity exhibited by the refrigerant at the first evaporator 17 (an enthalpy difference between the points i3 and h3 in FIG. 3) close to that exhibited by the refrigerant at the second evaporator 18 (an enthalpy difference between the points i3 and j3 in FIG. 3).

As a result, the cooling capacity of the first evaporator 17 can be made close to that of the second evaporator 18, which can prevent the temperature of the blown ventilation air from being different toward the front-seat side and the rear-seat side of the vehicle. The cooling capacity of the evaporator can be defined as a capacity for cooling a fluid to be cooled (in this embodiment, ventilation air) at a prescribed flow rate to a desired temperature.

In the ejector refrigeration cycle 10 of this embodiment, the decompression characteristics (flow rate coefficients) of the high-pressure side fixed throttle 16a and the low-pressure side fixed throttle 16b are determined such that the pressure of refrigerant at the refrigerant inlet side of the first evaporator 17 becomes substantially equal to that of refrigerant at the refrigerant inlet side of the second evaporator 18. The upstream-side refrigerant suction port 42a of the upstream-side ejector 14 is coupled to both the refrigerant outlet side of the first evaporator 17 and the refrigerant outlet side of the second evaporator 18 via the merging portion 13b.

The refrigerant evaporation pressure (refrigerant evaporation temperature) at the first evaporator 17 can be made close to that at the second evaporator 18, whereby the cooling capacity of the first evaporator 17 can be more effectively made close to that of the second evaporator 18.

In the upstream-side nozzle 41 of the upstream-side ejector 14 in this embodiment, the refrigerant swirls in the swirling space 41c, whereby the refrigerant pressure at the swirling center side of the swirling space 41c is reduced to a pressure that generates the saturated liquid-phase refrigerant, or a pressure at which the refrigerant is decompressed and boils (causing cavitation). As a result, the gas-phase refrigerant exists more on the inner peripheral side of the swirling central axis rather than the outer peripheral side thereof, so that the inside of the swirling space 41c can be brought into two-phase separated states, in which the single gas phase is positioned near the swirling central line of the swirling space 41c, while the single liquid phase is positioned around the gas phase.

The refrigerant in such a two-phase separated state flows into the tapered portion 41e of the upstream-side nozzle 41. In the tapered portion 41e, the boiling of the refrigerant is promoted by the boiling on a wall surface caused when the refrigerant is removed from the wall surface of the outer peripheral side of the central axis, as well as the boiling at the interface caused by the nucleate boiling generated by the cavitation of the refrigerant on the central axis side of the refrigerant passage. Thus, the refrigerant flowing into the minimum passage area portion 41d is brought substantially into the gas-liquid mixed state of uniformly mixing the gas phase and liquid phase.

Further, the flow of refrigerant including the mixed state of the gas-phase and liquid-phase refrigerants is blocked (choked) in the vicinity of the minimum passage area portion 41d, whereby the refrigerant in the liquid-gas mixed state reaches the sound velocity by the choking and is further accelerated by the expanding portion 41f to be injected therefrom. In this way, the promotion of boiling due to both wall-surface boiling and interface boiling can efficiently accelerate the refrigerant in the gas-liquid mixed state up to the sound velocity, thereby improving an energy conversion efficiency (nozzle efficiency) of converting the pressure energy of the refrigerant into the kinetic energy thereof in the upstream-side nozzle 41.

Further, the radiator 12 of this embodiment includes the receiver 12b serving as the high-pressure side gas-liquid separator, whereby the liquid-phase refrigerant can be surely supplied into the swirling space 41c that is formed in the cylindrical portion 41g of the upstream-side ejector 14 configuring the swirling-flow generating portion. This embodiment can surely improve the nozzle efficiency by supplying the refrigerant swirling in the swirling space 41c to the nozzle.

### Second Embodiment

As shown in the entire configuration diagram of FIG. 4, this embodiment will describe an example in which an internal heat exchanger 19 for exchanging heat between the high-pressure refrigerant on the downstream-side of the radiator 12 and the low-pressure refrigerant on the suction side of the compressor 11 is added, compared to the ejector refrigeration cycle 10 of the first embodiment. Referring to FIG. 4, the same or equivalent parts as those described in the first embodiment are designated by the same reference numerals. The same goes for the following figures.

More specifically, in this embodiment, one refrigerant inflow port of the merging portion 13b is coupled to the gas-phase refrigerant outflow side of the gas-liquid separator 15, while the other refrigerant inflow port of the merging portion 13b is coupled to the refrigerant outlet side of the second evaporator 18. Further, the inlet side of the low-pressure refrigerant passage in the internal heat exchanger 19 is coupled to the refrigerant outflow port of the merging portion 13b.

The internal heat exchanger 19 exchanges heat between the high-pressure refrigerant circulating through the refrigerant flow path leading from the upstream-side branch portion 13a to the high-pressure side fixed throttle 16a among the high-pressure refrigerants on the downstream-side of the radiator 12, and the low-pressure refrigerant circulating through the refrigerant flow path leading from the merging portion 13b to the suction port of the compressor 11 among the low-pressure refrigerants on the suction side of the compressor 11.

The low-pressure refrigerant circulating through the refrigerant flow path leading from the merging portion 13b to the suction port of the compressor 11 becomes the low-pressure refrigerant formed by merging the gas-phase refrigerant flowing out of the gas-liquid separator 15 with the refrigerant flowing out of the second evaporator 18.

Such an internal heat exchanger 19 can employ a double-pipe heat exchanger or the like that includes an inner pipe forming a low-pressure refrigerant passage for circulation of the low-pressure refrigerant and an outer pipe disposed outside the inner pipe and forming a high-pressure refrigerant passage for circulation of the high-pressure refrigerant. Obviously, a structure may be employed which includes an outer pipe forming the low-pressure refrigerant passage and an inner pipe disposed inside the outer pipe and forming the high-pressure refrigerant passage. The structures of other components of the ejector refrigeration cycle 10 except for the above points are the same as those of the first embodiment.

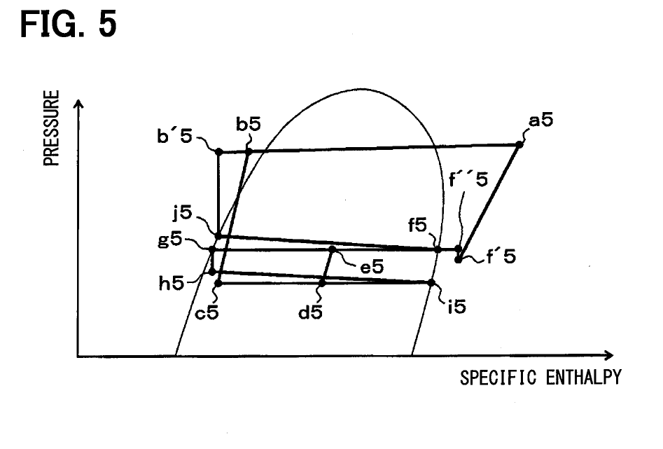

Next, the operation of the above-mentioned structure according to this embodiment will be described with reference to the Mollier diagram of FIG. 5. Each reference character indicative of the state of refrigerant in the Mollier diagram of FIG. 5 is represented by using the same letter of alphabet, with only a different number attached thereto, as the reference character for the state of refrigerant at the equivalent position on the cycle in the Mollier diagram of FIG. 3 in the first embodiment. The same goes for other Mollier charts below.

When the ejector refrigeration cycle 10 of this embodiment is operated, the refrigerant discharged from the compressor 11 flows from the radiator 12 to the upstream-side branch portion 13a like the first embodiment. One refrigerant branched by the upstream-side branch portion 13a is isentropically decompressed at the upstream-side nozzle 41 of the upstream-side ejector 14 (as indicated from a point a5 to a point b5 and then to a point c5 in FIG. 5).

In this way, the refrigerant flowing out of the first evaporator 17 is drawn from the upstream-side refrigerant suction port 42a and merged with an upstream-side injection refrigerant (as indicated from the point c5 to a point d5 and from a point i5 to the point d5 in FIG. 5). The upstream-side injection refrigerant and an upstream-side suction refrigerant drawn from the upstream-side refrigerant suction port 42a are pressurized by the upstream-side diffuser 42b while being mixed together (as indicated from the point d5 to a point e5 in FIG. 5), and separated into gas and liquid phase refrigerants by the gas-liquid separator 15 (as indicated from the point e5 to a point f5, and from the point e5 to a point g5 in FIG. 5).

The gas-phase refrigerant separated by the gas-liquid separator 15 flows into the merging portion 13b to be merged with the refrigerant flowing out of the second evaporator 18, and then the merged refrigerant flows into the low-pressure refrigerant passage of the internal heat exchanger 19. The liquid-phase refrigerant separated by the gas-liquid separator 15, like the first embodiment, is decompressed by the low-pressure side fixed throttle 16b (as indicated from the point g5 to a point h5 in FIG. 5), and absorbs heat from the front-seat side ventilation air blown from the blower fan 17a in the first evaporator 17 to evaporate itself (as indicated from the point h5 to the point i5 in FIG. 5).

On the other hand, the other refrigerant branched at the upstream-side branch portion 13a flows into the high-pressure refrigerant passage at the internal heat exchanger 19 to exchange heat with the low-pressure refrigerant circulating through the low-pressure refrigerant passage, resulting in a decrease in enthalpy thereof (as indicated from the point b5 to a point b′5 in FIG. 5). In contrast, the low-pressure refrigerant circulating through the low-pressure refrigerant passage has its enthalpy increased (as indicated from the point f5 to a point f″5 in FIG. 5).

The refrigerant flowing out of the high-pressure refrigerant passage in the internal heat exchanger 19 is decompressed by the high-pressure side fixed throttle 16a (as indicated from the point b′5 to a point j5 in FIG. 5), and absorbs heat from the rear-seat side ventilation air blown from the blower fan 18a in the second evaporator 18 to evaporate itself (as indicated from the point j5 to the point f5 in FIG. 5), like the first embodiment. The refrigerant flowing out of the low-pressure refrigerant passage in the internal heat exchanger 19 is drawn into the suction port of the compressor 11 and compressed again by the compressor 11 (as indicated from the point f′5 to the point a5 of FIG. 5).

The ejector refrigeration cycle 10 of this embodiment operates in the manner described above and thus can obtain the same effects as in the first embodiment. That is, the front-seat side ventilation air and the rear-seat side ventilation air can be cooled, which can prevent the temperature of the ventilation air from being made nonuniform between the front-seat side and the rear-seat side of the vehicle at this time.

More specifically, in the ejector refrigeration cycle 10 of this embodiment, like the first embodiment, the liquid-phase refrigerant separated by the gas-liquid separator 15 is allowed to flow toward the first evaporator 17, so that the refrigerant having a relatively low enthalpy can flow into the first evaporator 17 as indicated by the point h5 in FIG. 5. The refrigerant is cooled by the internal heat exchanger 19 and then isentropically decompressed by the high-pressure side fixed throttle 16a to flow into the second evaporator 18, so that the refrigerant having a relatively low enthalpy can also flow into the second evaporator 18 as indicated by the point j5 of FIG. 5.

Thus, the refrigeration capacity exhibited by the refrigerant at the first evaporator 17 (the enthalpy difference between the points i5 and h5 shown in FIG. 5) can be made close to that exhibited by the refrigerant at the second evaporator 18 (the enthalpy difference between the points f5 and j5 in FIG. 5), which can render the cooling capacity of the first evaporator 17 close to that of the second evaporator 18.

The ejector refrigeration cycle 10 of this embodiment includes the internal heat exchanger 19 and thus can decrease the enthalpy of the refrigerant flowing into the second evaporator 18, thereby enhancing the refrigeration capacity exhibited by the refrigerant at the second evaporator 18. Thus, as shown in the Mollier diagram of FIG. 5, even when the refrigerant evaporation temperature at the second evaporator 18 is higher than that at the first evaporator 17, this embodiment can suppress the cooling capacity of the first evaporator 17 from largely differing from that of the second evaporator 18.

In the ejector refrigeration cycle 10 of this embodiment, the low-pressure refrigerant flows into the low-pressure refrigerant passage in the internal heat exchanger 19, the low-pressure refrigerant including a mixture of the gas-phase refrigerant separated by the gas-liquid separator 15 and the refrigerant flowing out of the second evaporator 18. Thus, even if the liquid-phase refrigerant is mixed into the refrigerant flowing out of the second evaporator 18, the liquid-phase refrigerant can evaporate and vaporize at the internal heat exchanger 19, thereby preventing the liquid compression at the compressor 11.

### Third Embodiment

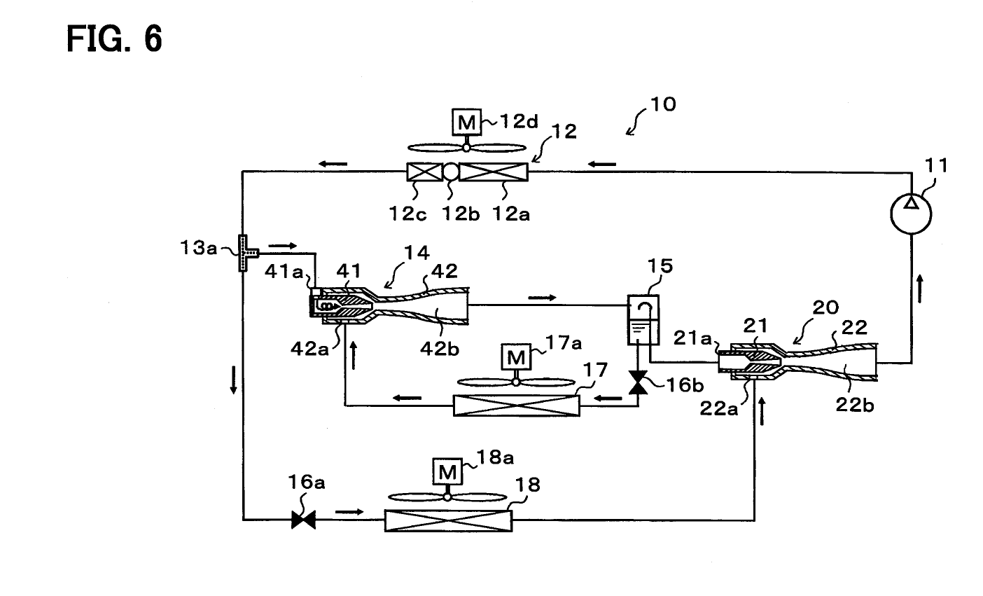

As shown in the entire configuration diagram of FIG. 6, this embodiment will describe an example in which a downstream-side ejector 20 is added to the ejector refrigeration cycle 10 of the first embodiment. The downstream-side ejector 20 has the same basic structure as that of the upstream-side ejector 14. Thus, the downstream-side ejector 20 includes a downstream-side nozzle 21 and a downstream-side body 22, which are substantially the same as those in the upstream-side ejector 14.

More specifically, the downstream-side nozzle 21 is provided with a refrigerant inflow port 21a that allows for inflow of the refrigerant. The downstream-side body 22 includes a downstream-side refrigerant suction port 22a and a downstream-side diffuser 22b. The downstream-side refrigerant suction port 22a draws the refrigerant by the suction effect of the downstream-side injection refrigerant injected from the downstream-side nozzle 21. The downstream-side diffuser 22b serves as the downstream-side pressurizing portion that pressurizes the mixture of the downstream-side injection refrigerant and another downstream-side suction refrigerant drawn from the downstream-side refrigerant suction port 22a.

Further, in the ejector refrigeration cycle 10 of this embodiment, the gas-phase refrigerant outflow port of the gas-liquid separator 15 is coupled to the side of the refrigerant inflow port 21a of the downstream-side nozzle 21 in the downstream-side ejector 20, while a liquid-phase refrigerant outflow port of the gas-liquid separator 15 is coupled to the refrigerant inlet side of the first evaporator 17. The refrigerant outflow port of the second evaporator 18 is coupled to the side of the downstream-side refrigerant suction port 22a in the downstream-side ejector 20.

That is, the gas-liquid separator 15 of this embodiment achieves not only the function of separating the refrigerant flowing out of the upstream-side ejector 14 into the gas and liquid phases, but also the function of serving as a downstream-side branch portion. Specifically, the gas-liquid separator 15 is also adapted to branch the flows of the separated refrigerants to allow the branched gas-phase refrigerant to flow out to the refrigerant inflow port 21a of the downstream-side ejector 20, while allowing the branched liquid-phase refrigerant to flow out to the refrigerant inlet side of the first evaporator 17. The downstream-side ejector 20 also serves as a merging portion that merges the gas-phase refrigerant separated by the gas-liquid separator 15 with the refrigerant flowing out of the second evaporator 18.

Note that since the gas-phase refrigerant flows into the refrigerant inflow port 21a of the downstream-side ejector 20, the downstream-side ejector 20 does not need to include a swirling-flow generating portion that generates a swirling flow in the refrigerant decompressed by the downstream-side nozzle 21. The structures of other components of the ejector refrigeration cycle 10 except for the above points are the same as those of the first embodiment.

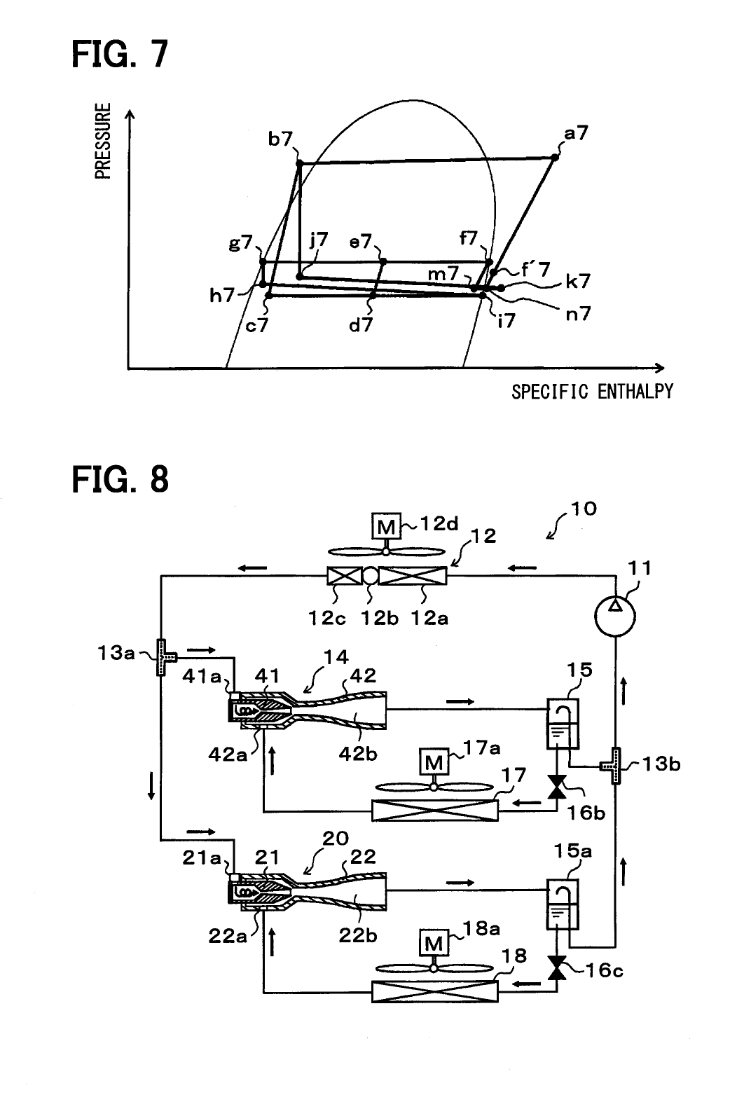

Next, the operation of the above-mentioned structure according to this embodiment will be described with reference to the Mollier diagram of FIG. 7. When the ejector refrigeration cycle 10 of this embodiment is operated, like the first embodiment, the refrigerant discharged from the compressor 11 flows from the radiator 12 to the upstream-side branch portion 13a. One refrigerant branched by the upstream-side branch portion 13a is isentropically decompressed at the upstream-side nozzle 41 of the upstream-side ejector 14 (as indicated from a point a7 to a point b7 and then to a point c7 in FIG. 7).

In this way, the refrigerant flowing out of the first evaporator 17 is drawn from the upstream-side refrigerant suction port 42a and merged with an upstream-side injection refrigerant (as indicated from the point c7 to a point d7, and from a point i7 to the point d7 in FIG. 7). Like the first embodiment, the refrigerant pressurized by the upstream-side diffuser 42b is separated into gas and liquid phase refrigerants by the gas-liquid separator 15 (as indicated from a point e7 to a point f7, and from the point e7 to a point g7 in FIG. 7).

The liquid-phase refrigerant separated by the gas-liquid separator 15 is decompressed by the low-pressure side fixed throttle 16b (as indicated from the point g7 to a point h7 in FIG. 7), and absorbs heat from the front-seat side ventilation air blown from the blower fan 17a in the first evaporator 17 to evaporate itself (as indicated from the point h7 to the point i7 in FIG. 7).

The gas-phase refrigerant separated by the gas-liquid separator 15 flows into the downstream-side nozzle 21 of the downstream-side ejector 20, and is isentropically decompressed and injected (as indicated from the point f7 to a point m7 in FIG. 7). The refrigerant flowing out of the second evaporator 18 is drawn from the downstream-side refrigerant suction port 22a by a suction effect of the injection refrigerant on the downstream-side that is injected from the downstream-side nozzle 21. The downstream-side injection refrigerant and the downstream-side suction refrigerant drawn from the downstream-side refrigerant suction port 22a flows into the downstream-side diffuser 22b (as indicated from the point m7 to a point n7, and from a point k7 to the point n7 in FIG. 7).

Like the upstream-side diffuser 42b, the downstream-side diffuser 22b pressurizes the mixed refrigerant of the downstream-side injection refrigerant and the downstream-side suction refrigerant while mixing these refrigerants together (as indicated from the point n7 to a point f′7 in FIG. 7). The refrigerant flowing out of the downstream-side diffuser 22b is drawn into the compressor 11 and compressed again (as indicated from the point f′7 to the point a7 in FIG. 7).

Meanwhile, the other refrigerant branched by the upstream-side branch portion 13a is decompressed by the high-pressure side fixed throttle 16a (as indicated from the point b7 to a point j7 in FIG. 7), and absorbs heat from the rear-seat side ventilation air blown from the blower fan 18a in the second evaporator 18 to evaporate itself, like the first embodiment (as indicated from the point j7 to the point k7 in FIG. 7). Further, the refrigerant flowing out of the second evaporator 18 is drawn from the downstream-side refrigerant suction port 22a of the downstream-side ejector 20.

The ejector refrigeration cycle 10 of this embodiment operates in the manner described above and thus can obtain the same effects as in the first embodiment. That is, the front-seat side ventilation air and the rear-seat side ventilation air can be cooled, which can prevent the temperature of the ventilation air from being made nonuniform between the front-seat side and the rear-seat side of the vehicle at this time.

More specifically, in the ejector refrigeration cycle 10 of this embodiment, like the first embodiment, the liquid-phase refrigerant separated by the gas-liquid separator 15 is allowed to flow toward the first evaporator 17, so that the refrigerant having a relatively low enthalpy can flow into the first evaporator 17 as indicated by the point h7 in FIG. 7. The refrigerant leaving the radiator 12 is isentropically decompressed by the high-pressure side fixed throttle 16a and then flows into the second evaporator 18, so that the refrigerant having a relatively low enthalpy can flow into the second evaporator 18 as indicated by the point j7 of FIG. 7.

Thus, the refrigeration capacity exhibited by the refrigerant at the first evaporator 17 (the enthalpy difference between the points i7 and h7 shown in FIG. 7) can be made close to that exhibited by the refrigerant at the second evaporator 18 (the enthalpy difference between the points k7 and j7 in FIG. 7), which can render the cooling capacity of the first evaporator 17 close to that of the second evaporator 18.

In the ejector refrigeration cycle 10 of this embodiment, the downstream-side ejector 20 is provided with the refrigerant outlet side of the second evaporator 18 coupled to the downstream-side refrigerant suction point 22a of the downstream-side ejector 20, whereby the refrigerant evaporation pressure at the second evaporator 18 can be made lower than the pressure of refrigerant flowing out of the downstream-side diffuser 22b.

The refrigerant evaporation pressure (refrigerant evaporation temperature) at the second evaporator 18 can be reduced to approach the refrigerant evaporation pressure (refrigerant evaporation temperature) at the first evaporator 17. As a result, the cooling capacity of the first evaporator 17 can be more effectively made close to that of the second evaporator 18.

### Fourth Embodiment

As shown in the entire configuration diagram of FIG. 8, this embodiment will describe an example in which a downstream-side ejector 20 is added to the ejector refrigeration cycle 10 of the first embodiment. The downstream-side ejector 20 of this embodiment includes a swirling-flow generating portion, which is the same as that in the first embodiment, compared to the downstream-side ejector 20 of the third embodiment. That is, in this embodiment, the downstream-side ejector 20 is used which has substantially the same structure as that of the upstream-side ejector 14.

Further, in the ejector refrigeration cycle 10 of this embodiment, one refrigerant outflow port of the upstream-side branch portion 13a is coupled to the side of the refrigerant inflow port 41a of the upstream-side nozzle 41 in the upstream-side ejector 14, while the other refrigerant outflow port of the upstream-side branch portion 13a is coupled to the side of the refrigerant inflow port 21a of the downstream-side nozzle 21 in the downstream-side ejector 20.

The downstream-side of the downstream-side diffuser 22b in the downstream-side ejector 20 is coupled to a downstream-side gas-liquid separator 15a. The downstream-side gas-liquid separator 15a is a low-pressure side gas-liquid separator having the substantially same structure as that of the gas-liquid separator 15. In this embodiment, the gas-liquid separator 15 will be referred to as the “upstream-side gas-liquid separator 15” to clarify the explanation.

The gas-phase refrigerant outflow port of the upstream-side gas-liquid separator 15 and the gas-phase refrigerant outflow port of the downstream-side gas-liquid separator 15a are coupled to the suction port side of the compressor 11 via the merging portion 13b. The liquid-phase refrigerant outflow port of the downstream-side gas-liquid separator 15a is coupled to the refrigerant inlet side of the second evaporator 18 via a second low-pressure side fixed throttle 16c, which has the substantially same structure as that of the low-pressure side fixed throttle 16b. The refrigerant outlet of the second evaporator 18 is coupled to the downstream-side refrigerant suction port 22a in the downstream-side ejector 20.

That is, in the ejector refrigeration cycle 10 of this embodiment, two units are connected in parallel with respect to the flow of refrigerant. One of these units is an upstream-side unit that includes the upstream-side ejector 14, the upstream-side gas-liquid separator 15, the low-pressure side fixed throttle 16b, and the first evaporator 17, whereas the other is a downstream-side unit that includes the downstream-side ejector 20, the downstream-side gas-liquid separator 15a, the second low-pressure side fixed throttle 16c, and the second evaporator 18. The structures of other components in this embodiment are the same as those in the first embodiment.

Therefore, when the ejector refrigeration cycle 10 of this embodiment is operated, the front-seat side ventilation air and the rear-seat side ventilation air can be cooled, while the COP of the cycle can be improved by the pressurizing effect of the upstream-side diffuser 42b of the upstream-side ejector 14 as well as the downstream-side diffuser 22b of the downstream-side ejector 20.

Further, the ejector refrigeration cycle 10 of this embodiment is configured to decompress the refrigerant flowing into the first evaporator 17 by the upstream size nozzle 41 and the low-pressure side fixed throttle 16b, and to decompress the refrigerant flowing into the second evaporator 18 by the downstream-side nozzle 21 and the second low-pressure side fixed throttle 16c.

Thus, the refrigerant evaporation temperature at the first evaporator 17 can be easily set substantially equal to that at the second evaporator 18. Likewise, the flow rate of refrigerant flowing into the first evaporator 17 can be easily set substantially equal to that into the second evaporator 18.

Additionally, the refrigeration cycle is configured to allow the liquid-phase refrigerant separated by the gas-liquid separator 15 to flow into the first evaporator 17 and to allow the liquid-phase refrigerant separated by the downstream-side gas-liquid separator 15a to flow into the second evaporator 18.

The dryness of refrigerant flowing into the first evaporator 17 can be easily set substantially equal to that of refrigerant flowing into the second evaporator 18. Accordingly, the refrigeration capacity exhibited by the refrigerant at the first evaporator 17 can be made close to that exhibited by the refrigerant at the second evaporator 18.

As a result, in the ejector refrigeration cycle 10 of the fourth embodiment, the cooling capacity of the first evaporator 17 can be effectively made close to that of the second evaporator 18.

### Fifth Embodiment

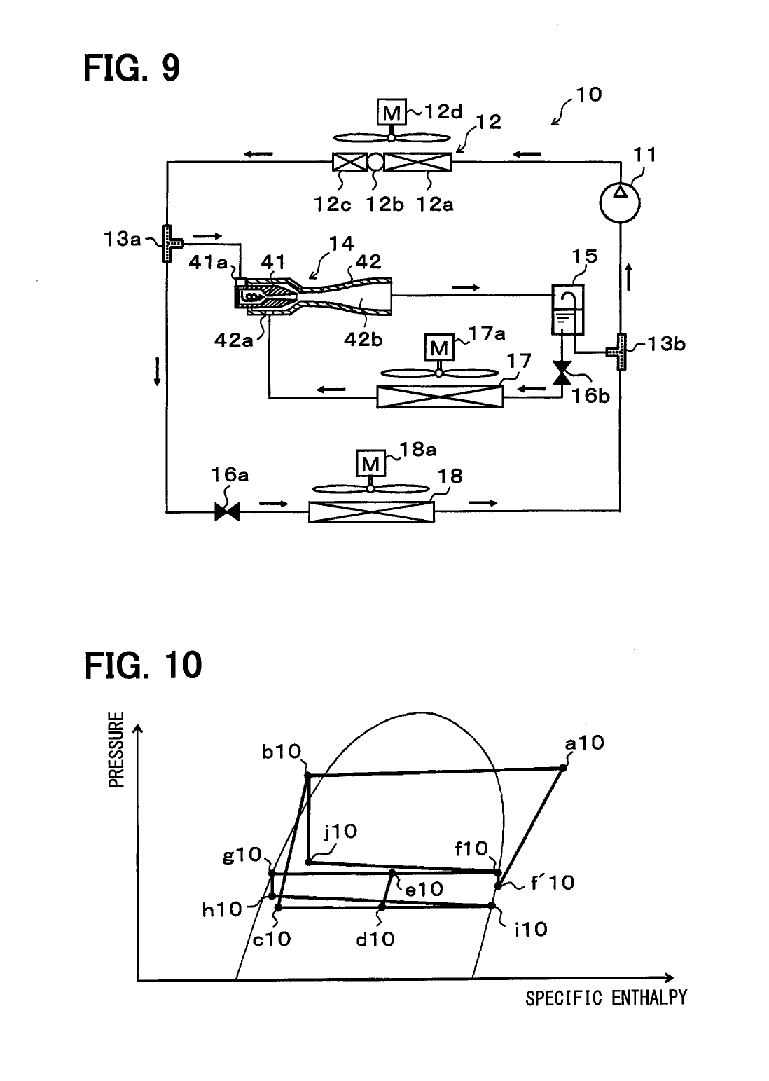

As shown in FIG. 9, this embodiment is obtained by changing the connection form of the merging portion 13b, compared to the ejector refrigeration cycle 10 of the first embodiment. Specifically, in this embodiment, one refrigerant inflow side of the merging portion 13b is coupled to the gas-phase refrigerant outflow port of the gas-liquid separator 15, and the other refrigerant inflow side of the merging portion 13b is coupled to the refrigerant outlet of the second evaporator 18. Further, the suction port side of the compressor 11 is coupled to the refrigerant outflow port of the merging portion 13b. The structures of other components of the ejector refrigeration cycle 10 except for the above points are the same as those of the first embodiment.

Next, the operation of the above-mentioned structure according to this embodiment will be described with reference to the Mollier diagram of FIG. 10. When the ejector refrigeration cycle 10 of this embodiment is operated, the refrigerant discharged from the compressor 11 flows from the radiator 12 to the upstream-side branch portion 13a like the first embodiment. One refrigerant branched by the upstream-side branch portion 13a is isentropically decompressed at the upstream-side nozzle 41 of the upstream-side ejector 14 (as indicated from a point a10 to a point b10 and then to a point c10 in FIG. 10).

In this way, the refrigerant flowing out of the first evaporator 17 is drawn from the upstream-side refrigerant suction port 42a to be merged with the upstream-side injection refrigerant (as indicated from the point c10 to a point d10, and from a point i10 to the point d10 in FIG. 10) and then pressurized by the upstream-side diffuser 42b (as indicated from the point d10 to a point e10 in FIG. 10). Further, the refrigerant pressurized by the upstream-side diffuser 42b is separated into gas and liquid phase refrigerants by the gas-liquid separator 15 (as indicated from the point e10 to a point f10, and from the point e10 to a point g10 in FIG. 10).

The liquid-phase refrigerant separated by the gas-liquid separator 15 is decompressed by the low-pressure side fixed throttle 16b (as indicated from the point g10 to a point h10 in FIG. 10), and absorbs heat from the front-seat side ventilation air blown from the blower fan 17a in the first evaporator 17 to evaporate itself (as indicated from the point h10 to a point i10 in FIG. 10). The gas-phase refrigerant separated by the gas-liquid separator 15 flows into the merging portion 13b to be merged with the refrigerant flowing out of the second evaporator 18.

Like the first embodiment, the other refrigerant branched by the upstream-side branch portion 13a is decompressed by the high-pressure side fixed throttle 16a (as indicated from the point b10 to a point j10 in FIG. 10) and absorbs heat from the rear-seat side ventilation air blown from the blower fan 18a in the second evaporator 18 to evaporate itself (as indicated from the point j10 to the point f10 in FIG. 10).

Further, the refrigerant leaving the second evaporator 18 flows into the merging portion 13b to be merged with the gas-phase refrigerant separated by the gas-liquid separator 15. The refrigerant flowing out of the merging portion 13b is drawn into the compressor 11 and compressed again (as indicated from a point f′10 to the point a10 in FIG. 10).

The ejector refrigeration cycle 10 of this embodiment operates in the manner described above and thus can obtain the same effects as in the first embodiment. That is, the liquid-phase refrigerant separated by the gas-liquid separator 15 is allowed to flow into the first evaporator 17, so that the refrigeration capacity exhibited by the refrigerant at the first evaporator 17 can be made close to that exhibited by the refrigerant at the second evaporator 18.

In the structure of the ejector refrigeration cycle 10 of this embodiment, the gas-phase refrigerant outflow side of the gas-liquid separator 15 is coupled to the refrigerant outlet side of the second evaporator 18 via the merging portion 13b. Thus, as shown in the Mollier diagram of FIG. 10, the refrigerant evaporation temperature at the second evaporator 18 is more likely to be higher than that at the first evaporator 17, causing the cooling capacity of the first evaporator 17 to differ from that of the second evaporator 18.

On the other hand, in this embodiment, the liquid-phase refrigerant separated by the gas-liquid separator 15 is allowed to flow into the first evaporator 17, so that the refrigeration capacity exhibited by the refrigerant at the first evaporator 17 can be made close to that exhibited by the refrigerant at the second evaporator 18. Thus, this embodiment can suppress the cooling capacity of the first evaporator 17 from largely differing from that of the second evaporator 18.

### Sixth to Ninth Embodiments

The sixth to ninth embodiments will describe modified examples of the ejector refrigeration cycle 10 that includes the internal heat exchanger 19 described in the second embodiment.

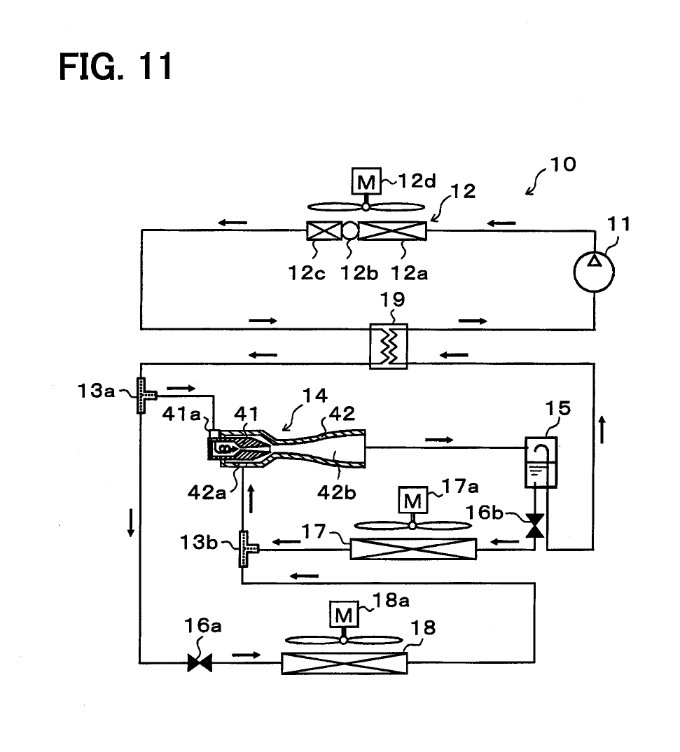

As shown in the entire configuration diagram of FIG. 11, in the sixth embodiment, the internal heat exchanger 19 is added to the ejector refrigeration cycle 10 described in the first embodiment. More specifically, the internal heat exchanger 19 of the sixth embodiment is disposed to exchange heat between the high-pressure refrigerant and the low-pressure refrigerant. The high-pressure refrigerant circulates through the refrigerant flow path leading from the outlet side of the radiator 12 to the upstream-side branch portion 13a in the high-pressure refrigerant on the downstream-side of the radiator 12. The low-pressure refrigerant circulates through the refrigerant flow path leading from the gas-phase refrigerant outflow port of the gas-liquid separator 15 to the suction port of the compressor 11 in the low-pressure refrigerant on the suction side of the compressor 11.

The ejector refrigeration cycle 10 of the sixth embodiment can obtain the same effects as those of the first embodiment, and additionally can reduce the enthalpy of the refrigerant flowing into the second evaporator 18, thereby enhancing the refrigeration capacity exhibited by the refrigerant at the second evaporator 18.

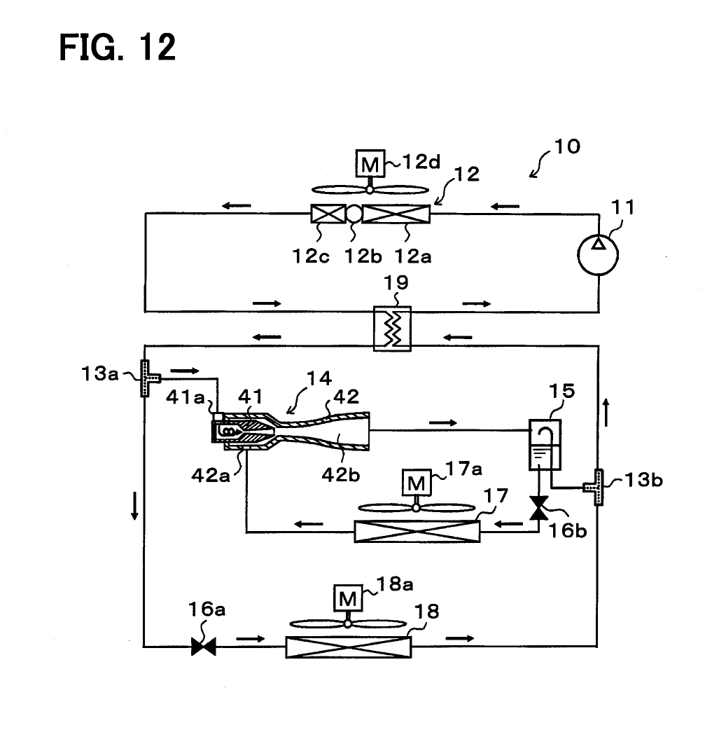

As shown in the entire configuration diagram of FIG. 12, in the seventh embodiment, the internal heat exchanger 19 is added to the ejector refrigeration cycle 10 described in the fifth embodiment. More specifically, the internal heat exchanger 19 of the seventh embodiment is disposed to exchange heat between the high-pressure refrigerant and the low-pressure refrigerant. The high-pressure refrigerant circulates through the refrigerant flow path leading from the outlet side of the radiator 12 to the upstream-side branch portion 13a, among high-pressure refrigerants on the downstream-side of the radiator 12. The low-pressure refrigerant circulates through the refrigerant flow path leading from the refrigerant outflow port of the merging portion 13b to the suction port of the compressor 11, among low-pressure refrigerants on the suction side of the compressor 11.

The ejector refrigeration cycle 10 of the seventh embodiment can obtain the same effects as those of the fifth embodiment, and additionally can reduce the enthalpy of the refrigerant flowing into the second evaporator 18, thereby enhancing the refrigeration capacity exhibited by the refrigerant at the second evaporator 18.

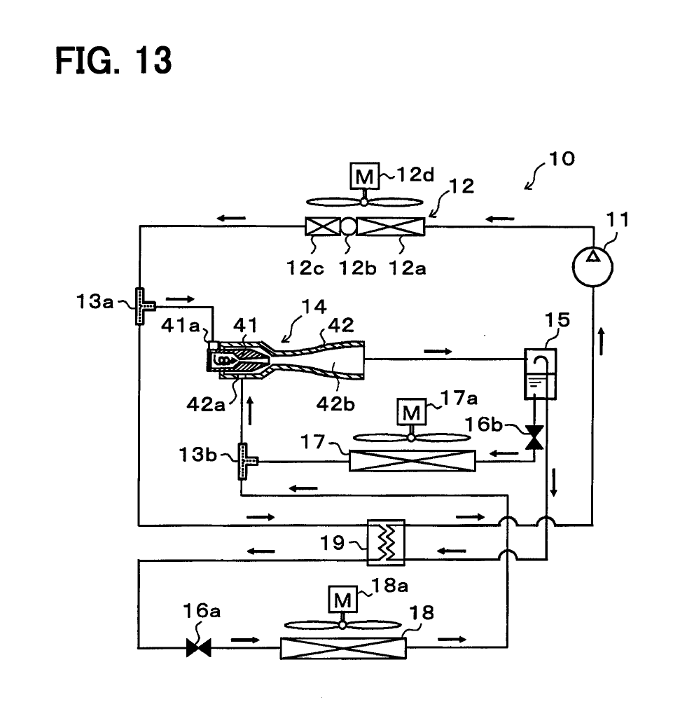

As shown in the entire configuration diagram of FIG. 13, in the eighth embodiment, the internal heat exchanger 19 is added to the ejector refrigeration cycle 10 described in the first embodiment. More specifically, the internal heat exchanger 19 of the eighth embodiment is disposed to exchange heat between the high-pressure refrigerant and the low-pressure refrigerant. The high-pressure refrigerant circulates through the refrigerant flow path leading from the upstream-side branch portion 13a to the high-pressure side fixed throttle 16a, among high-pressure refrigerants on the downstream-side of the radiator 12. The low-pressure refrigerant circulates through the refrigerant flow path leading from the gas-phase refrigerant outflow port of the gas-liquid separator 15 to the suction port of the compressor 11, among the low-pressure refrigerants on the suction side of the compressor 11.

The ejector refrigeration cycle 10 of the eighth embodiment can obtain the same effects as those of the first embodiment, and additionally can reduce the enthalpy of the refrigerant flowing into the second evaporator 18, thereby enhancing the refrigeration capacity exhibited by the refrigerant at the second evaporator 18.

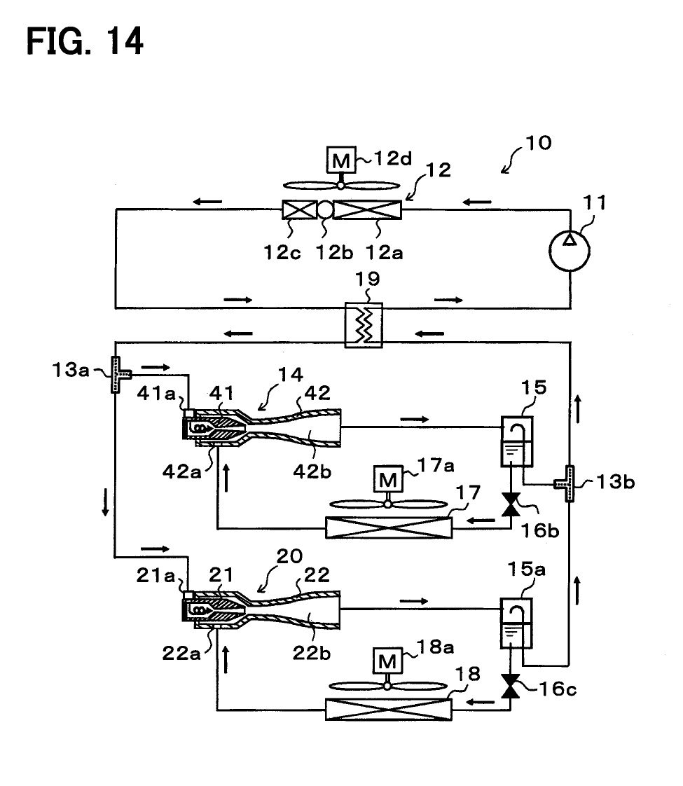

As shown in the entire configuration diagram of FIG. 14, the ninth embodiment is obtained by adding the internal heat exchanger 19 to the ejector refrigeration cycle 10 described in the fourth embodiment. More specifically, the internal heat exchanger 19 of the ninth embodiment is disposed to exchange heat between the high-pressure refrigerant and the low-pressure refrigerant. The high-pressure refrigerant circulates through the refrigerant flow path leading from the outlet side of the radiator 12 to the upstream-side branch portion 13a, among high-pressure refrigerants on the downstream-side of the radiator 12. The low-pressure refrigerant circulates through the refrigerant flow path leading from the merging portion 13b to the suction port of the compressor 11, among low-pressure refrigerants on the suction side of the compressor 11.

The ejector refrigeration cycle 10 of the ninth embodiment can obtain the same effects as those of the fourth embodiment, and additionally can reduce the enthalpy of the refrigerant flowing into both first evaporator 17 and second evaporator 18, thereby enhancing the refrigeration capacity exhibited by the refrigerant at both evaporators 17 and 18.

Alternatively, the internal heat exchanger 19 in the ejector refrigeration cycle 10 of the ninth embodiment may be disposed to exchange heat between the high-pressure refrigerant circulating through the refrigerant flow path leading from the outlet side of the radiator 12 to the upstream-side branch portion 13a, and the low-pressure refrigerant circulating through the refrigerant flow path leading from the gas-phase refrigerant outflow port of the gas-liquid separator 15 to the merging portion 13b.

Alternatively, the internal heat exchanger 19 may be disposed to exchange heat between the high-pressure refrigerant circulating through the refrigerant flow path from the outlet side of the radiator 12 to the upstream-side branch portion 13a, and the low-pressure refrigerant circulating through the refrigerant flow path from the gas-phase refrigerant outflow port of the downstream-side gas-liquid separator 15a to the merging portion 13b.

### Tenth Embodiment

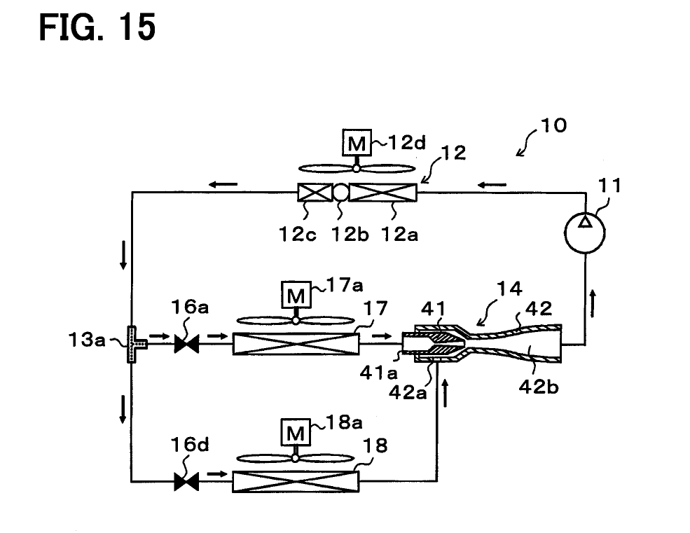

In an ejector refrigeration cycle 10 of this embodiment, as shown in the entire configuration diagram of FIG. 15, one refrigerant outflow port of the upstream-side branch portion 13a is coupled to the refrigerant inlet side of the first evaporator 17 via the high-pressure side fixed throttle 16a, and the other refrigerant outflow port of the upstream-side branch portion 13a is coupled to the refrigerant inlet side of the second evaporator 18 via a second high-pressure side fixed throttle 16d. The second high-pressure side fixed throttle 16d has the substantially same basic structure as that of the high-pressure side fixed throttle 16a.

The refrigerant outlet side of the first evaporator 17 is coupled to the side of the refrigerant inflow port 41a of the upstream-side nozzle 41 in the upstream-side ejector 14, while the refrigerant outlet side of the second evaporator 18 is coupled to the side of the upstream-side refrigerant suction port 42a in the upstream-side ejector 14. The upstream-side ejector 14 of this embodiment does not include a swirling-flow generating portion, like the downstream-side ejector 20 of the third embodiment.

That is, in the ejector refrigeration cycle 10 of this embodiment, the upstream-side ejector 14 also serves as the merging portion that merges the refrigerant flowing out of the first evaporator 17 with the refrigerant flowing out of the second evaporator 18, whereby the first evaporator 17 and the second evaporator 18 are connected in parallel with respect to the refrigerant flow. The structures of other components in this embodiment are the same as those in the first embodiment.

Thus, when the ejector refrigeration cycle 10 of this embodiment is operated, although the refrigerant evaporation temperature at the first evaporator 17 might be higher than that at the second evaporator 18, the refrigeration capacity exhibited by the refrigerant at the first evaporator 17 can be made close to that at the second evaporator 18.

Further, the flow rate of refrigerant flowing into the first evaporator 17 as well as that of refrigerant flowing into the second evaporator 18 can be controlled by adjusting the decompression characteristics (flow rate coefficients) of the high-pressure side fixed throttle 16a and the second high-pressure side fixed throttle 16d, thus making the cooling capacity of the first evaporator 17 close to that of the second evaporator 18.

### Eleventh Embodiment

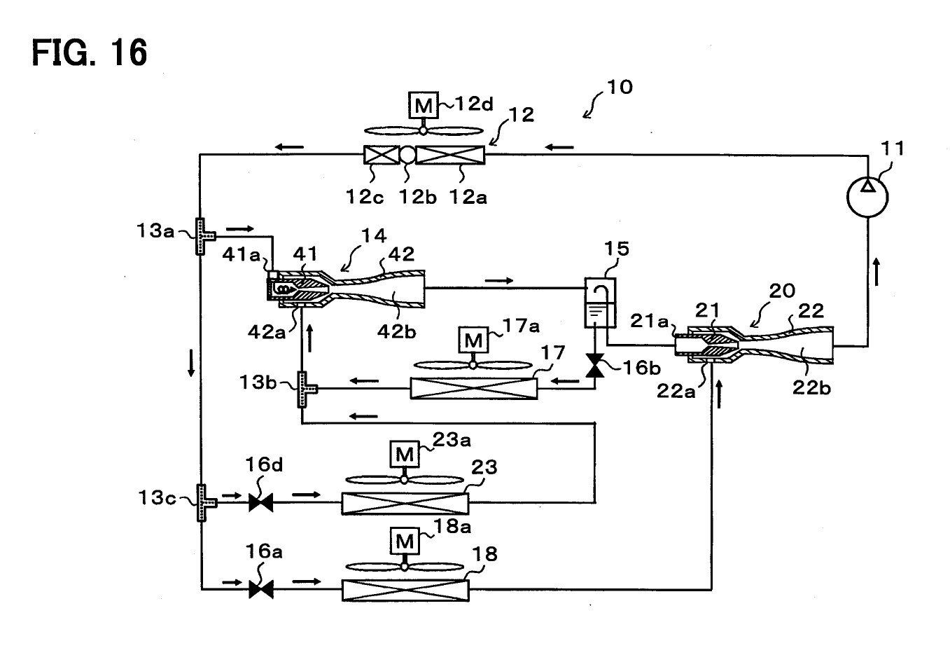

As shown in the entire configuration diagram of FIG. 16, this embodiment will describe an example in which an upstream-side auxiliary branch portion 13c, a second high-pressure side fixed throttle 16d, and a third evaporator 23 are added to the ejector refrigeration cycle 10 of the third embodiment.

The upstream-side auxiliary branch portion 13c has the substantially basic structure as that of the upstream-side branch portion 13a. The upstream-side auxiliary branch portion 13c further branches the flow of branched refrigerant flowing out of the other refrigerant outflow port of the upstream-side branch portion 13a, allowing one of the branched refrigerants to flow out toward the second high-pressure side fixed throttle 16d, while allowing the other branched refrigerant to flow out toward the high-pressure side fixed throttle 16a.

That is, the high-pressure side fixed throttle 16a of this embodiment serves as a decompression device that decompresses part of the other refrigerant branched by the upstream-side branch portion 13a, while the second high-pressure side fixed throttle 16d serves as an auxiliary decompression device that decompresses another part of the other refrigerant branched by the upstream-side branch portion 13a.

The third evaporator 23 is a heat exchanger for heat absorption that exchanges heat between a low-pressure refrigerant decompressed by the second high-pressure side fixed throttle 16d and the front-seat side ventilation air to be blown from a blower fan 23a toward the front seat side of the vehicle compartment, thereby supplementarily cooling the front-seat side ventilation air. The refrigerant outlet side of the third evaporator 23 is coupled to the side of one refrigerant inflow port of the merging portion 13b. The blower fan 23a has the substantially basic structure as that of each of the blower fans 17a and 18a.

The other refrigerant inflow port of the merging portion 13b is coupled to the refrigerant outlet side of the first evaporator 17. The refrigerant outflow port of the merging portion 13b is coupled to the side of the upstream-side refrigerant suction port 42a of the upstream-side ejector 14. The structures of other components in this embodiment are the same as those in the third embodiment.

Thus, when the ejector refrigeration cycle 10 of this embodiment is operated, this embodiment can obtain the same effects as those of the third embodiment and can further cool the front-seat side ventilation air at the third evaporator 23.

Further, in this embodiment, the upstream-side refrigerant suction port 42a of the upstream-side ejector 14 is coupled to both the refrigerant outlet side of the first evaporator 17 and the refrigerant outlet side of the third evaporator 23 via the merging portion 13b. In this way, the refrigerant evaporation pressure (refrigerant evaporation temperature) at the first evaporator 17 can be made close to the refrigerant evaporation pressure (refrigerant evaporation temperature) at the third evaporator 23.

Note that although this embodiment has described the example in which the refrigerant outlet side of the third evaporator 23 is coupled to the upstream-side refrigerant suction port 42a of the upstream-side ejector 14, alternatively, the refrigerant outlet side of the third evaporator 23 may be connected to the downstream-side refrigerant suction port 22a of the downstream-side ejector 20 to thereby cool the rear-seat side ventilation air at the third evaporator 23. Further, alternatively, the third evaporator 23 may cool ventilation air to be blown to another space to be cooled.

### Twelfth Embodiment

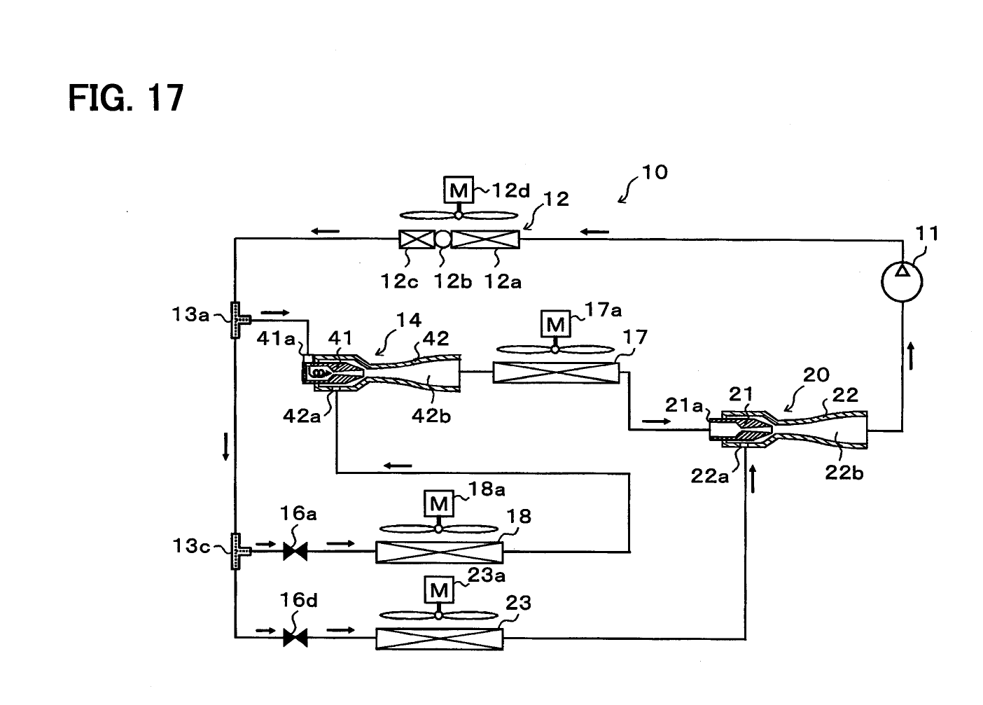

As shown in the entire configuration diagram of FIG. 17, this embodiment will describe an example in which the gas-liquid separator 15 is abolished, and the outlet side of the upstream-side diffuser 42b of the upstream-side ejector 14 is coupled to the refrigerant inlet side of the first evaporator 17, compared to the ejector refrigeration cycle 10 of the eleventh embodiment.

In this embodiment, the refrigerant outlet of the first evaporator 17 is coupled to the side of the refrigerant inflow port 21a of the downstream-side nozzle 21 in the downstream-side ejector 20. The refrigerant outlet of the second evaporator 18 is coupled to the side of the upstream-side refrigerant suction port 42a in the upstream-side ejector 14. The refrigerant outlet of the third evaporator 23 is coupled to the side of the downstream-side refrigerant suction port 22a of the downstream-side ejector 20. The structures of other components in this embodiment are the same as those in the eleventh embodiment.

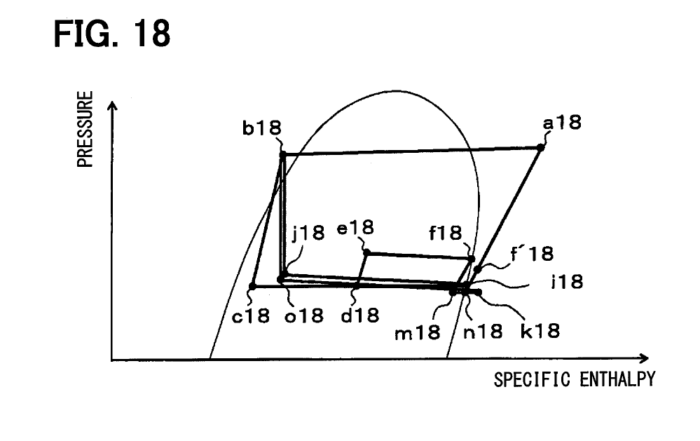

Next, the operation of the above-mentioned structure in this embodiment will be described with reference to the Mollier diagram of FIG. 18. When the ejector refrigeration cycle 10 of this embodiment is operated, the refrigerant discharged from the compressor 11 flows from the radiator 12 to the upstream-side branch portion 13a, like the first embodiment. One refrigerant branched by the upstream-side branch portion 13a is isentropically decompressed at the upstream-side nozzle 41 of the upstream-side ejector 14 (as indicated from a point a18 to a point b18 and then to a point c18 in FIG. 18).

In this way, the refrigerant flowing out of the second evaporator 18 is drawn from the upstream-side refrigerant suction port 42a to be merged with an upstream-side injection refrigerant (as indicated from the point c18 to a point d18 and from a point i18 to a point d18 in FIG. 18). The upstream-side injection refrigerant and the upstream-side suction refrigerant are pressurized by the upstream-side diffuser 42b while being mixed together (as indicated from the point d18 to a point e18 in FIG. 18).

The refrigerant leaving the upstream-side diffuser 42b flows into the first evaporator 17 and absorbs heat from the front-seat side ventilation air blown from the blower fan 17a to evaporate itself (as indicated from the point e18 to a point f18 in FIG. 18). In this way, the front-seat side ventilation air is cooled.

The refrigerant leaving the first evaporator 17 flows into the downstream-side nozzle 21 of the downstream-side ejector 20, and is isentropically decompressed (as indicated from the point f18 to a point m18 in FIG. 18). In this way, the refrigerant flowing out of the third evaporator 23 is drawn from the downstream-side refrigerant suction port 22a to be merged with a downstream-side injection refrigerant (as indicated from the point m18 to a point n18 and from the point k18 to a point n18 in FIG. 18).

The downstream-side injection refrigerant injected from the downstream-side nozzle 21 and the upstream-side suction refrigerant drawn from the downstream-side refrigerant suction port 22a are pressurized by the downstream-side diffuser 22b while being mixed together (as indicated from the point n18 to a point f′18 in FIG. 18). The refrigerant flowing out of the downstream-side diffuser 22b is drawn into the compressor 11 and compressed again (as indicated from the point f′18 to the point a18 in FIG. 18).

The flow of the other refrigerant branched by the upstream-side branch portion 13a flows into the upstream-side auxiliary branch portion 13c and is further branched thereby. One refrigerant branched by the upstream-side branch portion 13c is decompressed by the high-pressure side fixed throttle 16a (as indicated from a point b18 to a point j18 in FIG. 18) and absorbs heat from the rear-seat side ventilation air blown from the blower fan 18a in the second evaporator 18 to evaporate itself (as indicated from the point j18 to a point i18 in FIG. 18). In this way, the rear-seat side ventilation air is cooled. The refrigerant flowing out of the second evaporator 18 is drawn from the upstream-side refrigerant suction port 42a of the upstream-side ejector 14.

The other refrigerant branched by the upstream-side auxiliary branch portion 13c is decompressed by the second high-pressure side fixed throttle 16d (as indicated from a point b18 to a point o18 in FIG. 18) and absorbs heat from the front-seat side ventilation air blown from the blower fan 23a in the third evaporator 23 to evaporate itself (as indicated from the point o18 to a point k18 in FIG. 18). In this way, the front-seat side ventilation air is cooled. The refrigerant flowing out of the third evaporator 23 is drawn from the downstream-side refrigerant suction port 22a of the downstream-side ejector 20.

The ejector refrigeration cycle 10 of this embodiment operates in the manner described above and thus can cool the front-seat side ventilation air as well as the rear-seat side ventilation air. Further, the downstream-side ejector 20 is provided to allow the refrigerant flowing out of the third evaporator 23 to be pressurized and drawn into the compressor 11.

The density of the refrigerant drawn into the compressor 11 can be increased, thereby enhancing the flow rate of discharged refrigerant without increasing the number of revolutions of the compressor 11, compared to the cycle structure that just draws the refrigerant flowing out of the third evaporator 23 into the compressor 11.

In the ejector refrigeration cycle 10 of this embodiment, the outlet side of the upstream-side diffuser 42b in the upstream-side ejector 14 is coupled to the refrigerant inlet side of the first evaporator 17, and the refrigerant outlet side of the first evaporator 17 is coupled to the upstream-side refrigerant suction port 42a of the upstream-side ejector 14. Thus, as shown in the Mollier diagram of FIG. 18, the refrigerant evaporation temperature at the first evaporator 17 might be more likely to be higher than that at the second evaporator 18, causing the cooling capacity of the first evaporator 17 to easily differ from that of the second evaporator 18.

However, in this embodiment as mentioned above, the flow rate of refrigerant discharged from the compressor 11 can be increased to adjust the decompression characteristics (flow rate coefficients) of the upstream-side nozzle 41, the high-pressure side fixed throttle 16a, and the second high-pressure side fixed throttle 16d as appropriate, whereby the flow rate of refrigerant flowing into the first evaporator 17 can be increased, compared to that into the second evaporator 18. As a result, the cooling capacity of the first evaporator 17 can be made close to that of the second evaporator 18.

### Thirteenth to Seventeenth Embodiments

Thirteenth to seventeenth embodiments will describe modified examples of the ejector refrigeration cycle 10 described in the twelfth embodiment and in which the refrigerant inlet side of the first evaporator 17 is coupled to the outlet side of the upstream-side diffuser 42b in the upstream-side ejector 14, and the refrigerant inflow port 21a of the downstream-side nozzle 21 in the downstream-side ejector 20 is coupled to the refrigerant outlet side of the first evaporator 17.

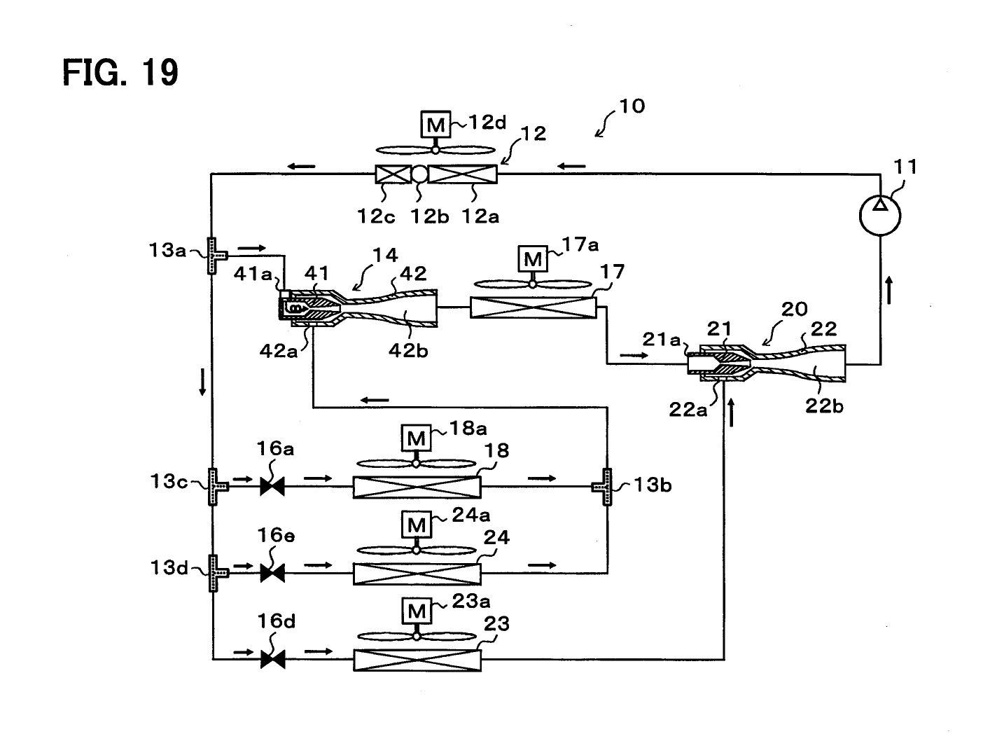

As shown in the entire configuration diagram of FIG. 19, the thirteenth embodiment will describe an example in which a second upstream-side auxiliary branch portion 13d, a third high-pressure side fixed throttle 16e, and a fourth evaporator 24 are added to the ejector refrigeration cycle 10 of the twelfth embodiment.

The second upstream-side auxiliary branch portion 13d has the substantially basic structure as that of the upstream-side branch portion 13a and the like. The second upstream-side auxiliary branch portion 13d further branches the flow of one refrigerant branched by the upstream-side auxiliary branch portion 13c, allowing one of the branched refrigerants to flow out toward the second high-pressure side fixed throttle 16d, while allowing the other branched refrigerant to flow out toward the third high-pressure side fixed throttle 16e, which is the second auxiliary decompression device.

The fourth evaporator 24 is a second auxiliary heat exchanger that exchanges heat between a low-pressure refrigerant decompressed by the third high-pressure side fixed throttle 16e and the rear-seat side ventilation air to be blown from a blower fan 24a toward the rear seat side of the vehicle compartment, thereby supplementarily cooling the rear-seat side ventilation air. The refrigerant outlet side of the third evaporator 23 is coupled to the side of one refrigerant inflow port of the merging portion 13b.

Further, the other refrigerant inflow port of the merging portion 13b is coupled to the refrigerant outlet side of the second evaporator 18. The refrigerant outflow port of the merging portion 13b is coupled to the side of the upstream-side refrigerant suction port 42a of the upstream-side ejector 14.

Thus, the ejector refrigeration cycle 10 of the thirteenth embodiment can obtain the same effects as those of the twelfth embodiment and can further cool the fluid to be cooled at the fourth evaporator 24 (in the thirteenth embodiment, the rear-seat side ventilation air).

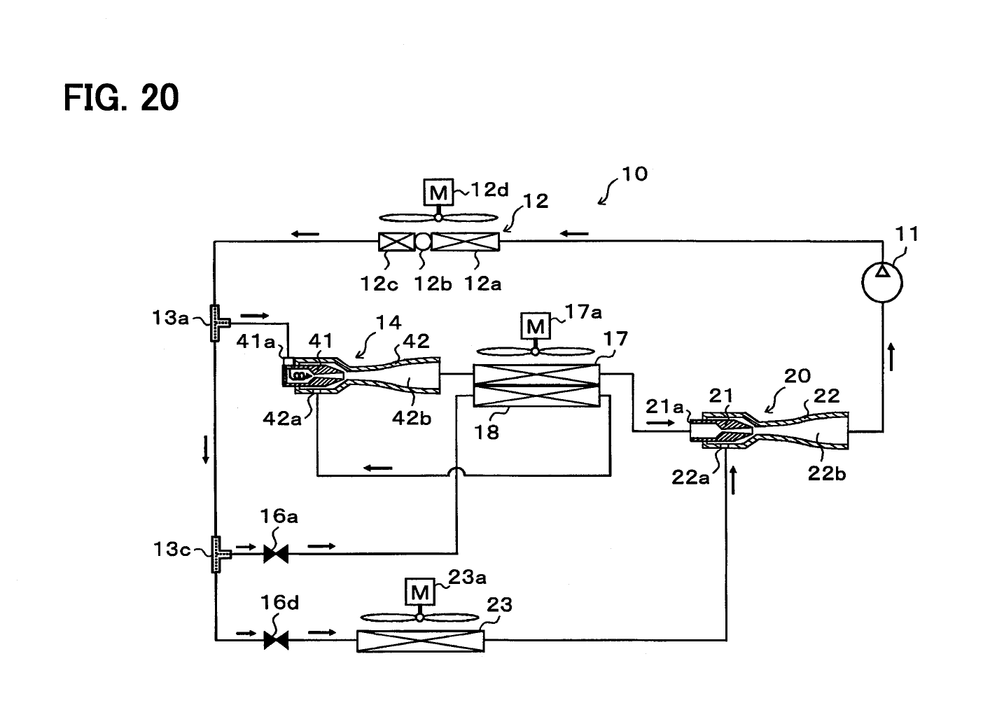

As shown in the entire configuration diagram of FIG. 20, the fourteenth embodiment will describe an example in which the blower fan 18a is abolished, and the first and second evaporators 17 and 18 are integrated with each other, with respect to the ejector refrigeration cycle 10 of the twelfth embodiment. Thus, in this embodiment, the ventilation air to be blown to the same space to be cooled is allowed to be cooled by both first evaporator 17 and second evaporator 18.

Note that as specific means for integrally forming these evaporators, the first evaporator 17 and the second evaporator 18 are proposed to be incorporated into the so-called tank-and-tube heat exchanger. The tank-and-tube heat exchanger includes a plurality of tubes for circulation of the refrigerant and a pair of distribution collecting tanks disposed on both ends in the longitudinal direction of the tubes and adapted to collect and distribute the refrigerant.

Then, the distribution collecting tanks for both evaporators are integrally formed, or both evaporators employ the common heat exchange fins for promoting heat exchange between the refrigerant and the ventilation air. Such means or the like can achieve the tank-and-tube heat exchanger.

In this embodiment, the first evaporator 17 and the second evaporator 18 are integrated with each other in such a manner that the first evaporator 17 is disposed on the windward side in the flow direction of the ventilation air with respect to the second evaporator 18, and the entire heat exchange core (that is a part for heat exchange between the refrigerant and air) of the first evaporator 17 is superimposed over the entire heat exchange core of the second evaporator 18 as viewed in the ventilation-air flow direction.

Therefore, in the ejector refrigeration cycle 10 of the fourteenth embodiment, the ventilation air is allowed to pass through the first evaporator 17 and the second evaporator 18 in this order to enable cooling of the same space to be cooled. Since the refrigerant evaporation temperature of the first evaporator 17 is higher than that of the second evaporator 18 at this time, a difference in temperature between the refrigeration evaporation temperature of each of the first and second evaporators 17 and 18 and the temperature of ventilation air can be ensured to effectively cool the ventilation air.

In the ejector refrigeration cycle 10 of the fourteenth embodiment, the first and second evaporators 17 and 18 may be used to cool the front-seat side ventilation air to be blown toward the front seat of the vehicle compartment, and the third evaporator 23 may be used to cool the rear-seat side ventilation air to be blown toward the rear seat thereof.

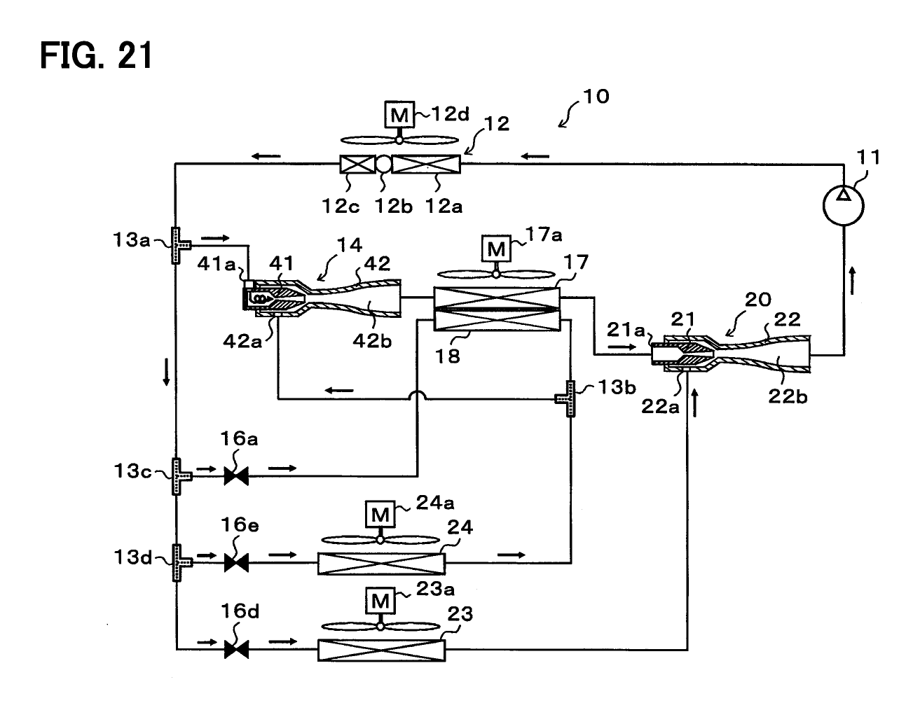

As shown in the entire configuration diagram of FIG. 21, in the fifteenth embodiment, like the fourteenth embodiment, the blower fan 18a is abolished, and the first and second evaporators 17 and 18 are integrated with each other, with respect to the ejector refrigeration cycle 10 of the thirteenth embodiment. Thus, the ejector refrigeration cycle 10 of the fifteenth embodiment can effectively cool the same space to be cooled, in the same way as in the fourteenth embodiment.

In the ejector refrigeration cycle 10 of the fifteenth embodiment, the first and second evaporators 17 and 18 may be used to cool the front-seat side ventilation air to be blown toward the front seat of the vehicle compartment, and at least one of the third and fourth evaporators 23 and 24 may be used to cool the rear-seat side ventilation air to be blown toward the rear seat thereof.

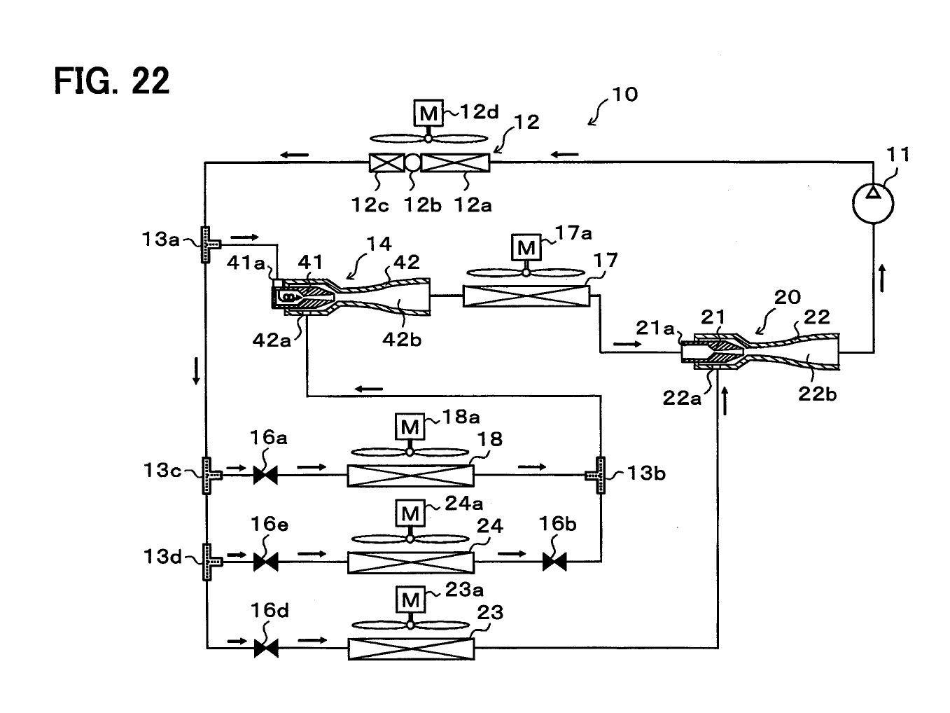

As shown in the entire configuration diagram of FIG. 22, in the sixteenth embodiment, the low-pressure side fixed throttle 16b is disposed between the refrigerant outlet side of the fourth evaporator 24 and the merging portion 13b, with respect to the ejector refrigeration cycle 10 of the thirteenth embodiment. This embodiment can obtain the same effects as those in the thirteenth embodiment and thus can raise the refrigerant evaporation temperature of the fourth evaporator 24, compared to that of the second evaporator 18.

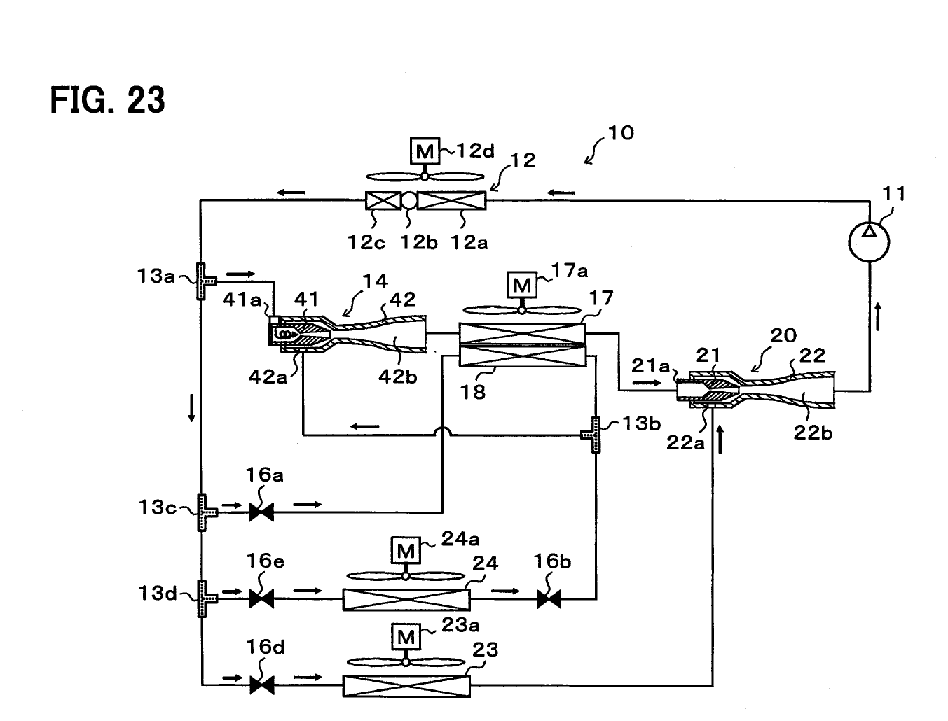

As shown in the entire configuration diagram of FIG. 23, in the seventeenth embodiment, the low-pressure side fixed throttle 16b is disposed between the refrigerant outlet side of the fourth evaporator 24 and the merging portion 13b, with respect to the ejector refrigeration cycle 10 of the fifteenth embodiment. This embodiment can obtain the same effects as those in the fifteenth embodiment and thus can raise the refrigerant evaporation temperature of the fourth evaporator 24, compared to that of the second evaporator 18.

### Eighteenth and Nineteenth Embodiments

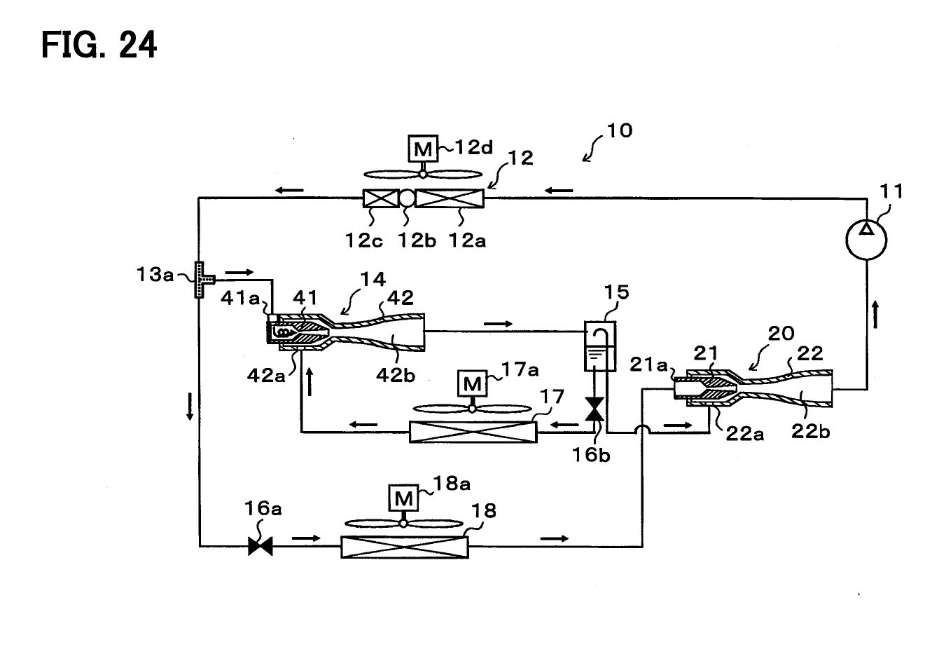

As shown in the entire configuration diagram of FIG. 24, in the eighteenth embodiment, the connection form of the downstream-side ejector 20 is changed from that of the ejector refrigeration cycle 10 in the third embodiment. Specifically, in this embodiment, the gas-phase refrigerant outflow port of the gas-liquid separator 15 is coupled to the side of the downstream-side refrigerant suction port 22a in the downstream-side ejector 20, while the refrigerant outlet of the second evaporator 18 is coupled to the side of the refrigerant inflow port 21a of the downstream-side nozzle 21 in the downstream-side ejector 20.

Therefore, when the ejector refrigeration cycle 10 of the eighteenth embodiment is operated, like the third embodiment, the cooling capacity of the first evaporator 17 can be made close to that of the second evaporator 18. Further, like the twelfth embodiment, the density of the refrigerant drawn into the compressor 11 can be increased by the pressurizing effect of the downstream-side ejector 20, thereby increasing the flow rate of refrigerant discharged from the compressor 11 without increasing the number of revolutions of the compressor 11.

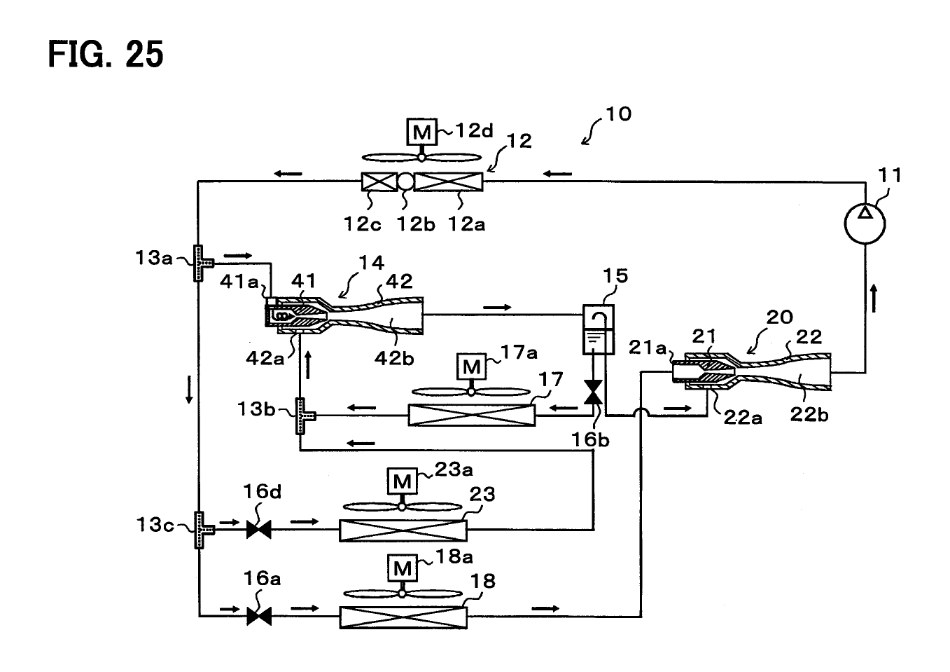

As shown in the entire configuration diagram of FIG. 25, in the nineteenth embodiment, the connection form of the downstream-side ejector 20 is changed from that of the ejector refrigeration cycle 10 in the eleventh embodiment. Specifically, in this embodiment, like the eighteenth embodiment, the gas-phase refrigerant outflow port of the gas-liquid separator 15 is coupled to the side of the downstream-side refrigerant suction port 22a of the downstream-side ejector 20, while the refrigerant outlet of the second evaporator 18 is coupled to the side of the refrigerant inflow port 21a of the downstream-side nozzle 21 in the downstream-side ejector 20.

Therefore, when the ejector refrigeration cycle 10 of the nineteenth embodiment is operated, the cooling capacity of the first evaporator 17 can be made close to that of the second evaporator 18 like the eleventh embodiment. Further, like the twelfth embodiment, the density of the refrigerant drawn into the compressor 11 can be increased by the pressurizing effect of the downstream-side ejector 20, thereby increasing the flow rate of refrigerant discharged from the compressor 11 without increasing the number of revolutions of the compressor 11.

### Twentieth to Twenty-Fifth Embodiments

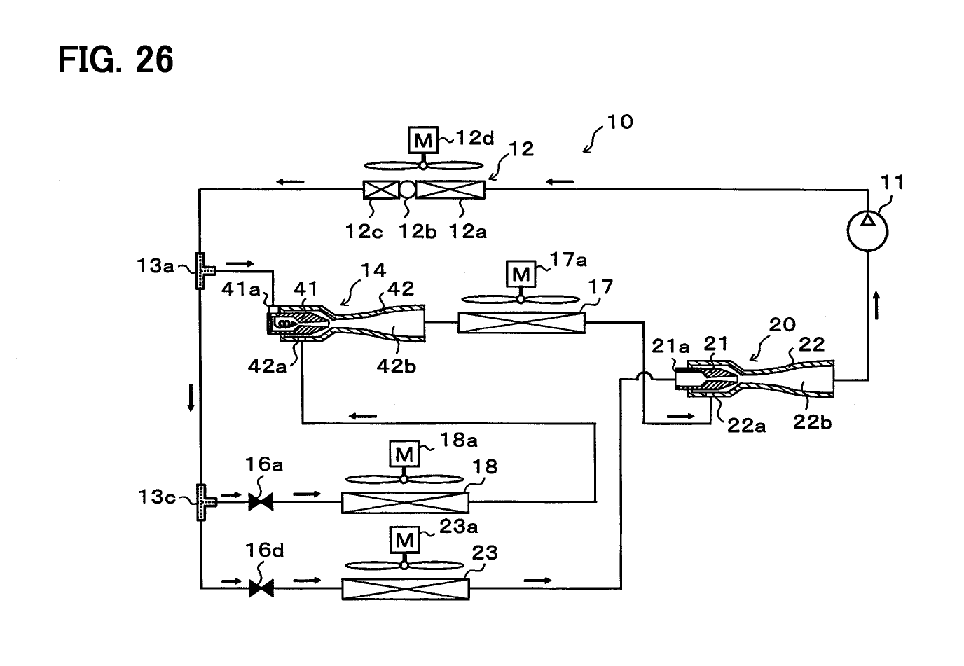

As shown in the entire configuration diagram of FIG. 26, in the twentieth embodiment, the connection form of the downstream-side ejector 20 is changed from that of the ejector refrigeration cycle 10 of the twelfth embodiment. Specifically, in this embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. As a result, such a cycle structure can also obtain the same effects as those of the twelfth embodiment.

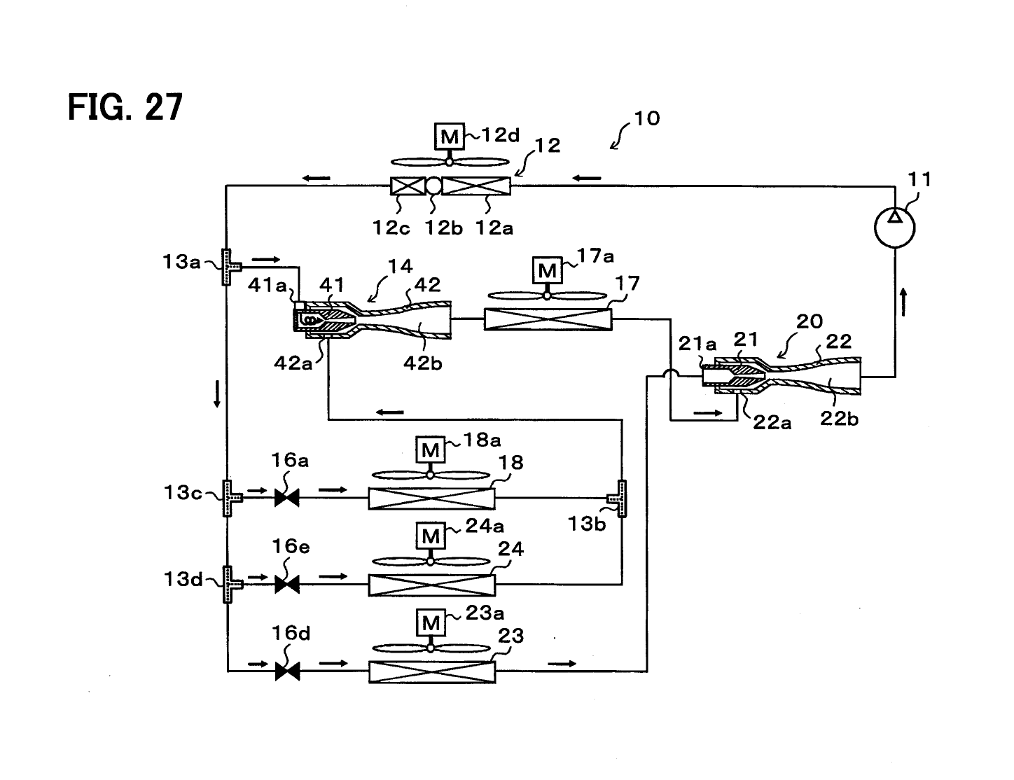

As shown in the entire configuration diagram of FIG. 27, in the twenty-first embodiment, the connection form of the downstream-side ejector 20 is changed from that of the ejector refrigeration cycle 10 of the thirteenth embodiment. Specifically, in this embodiment, like the twentieth embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. Such a cycle structure of this embodiment can also obtain the same effects as those of the thirteenth embodiment.

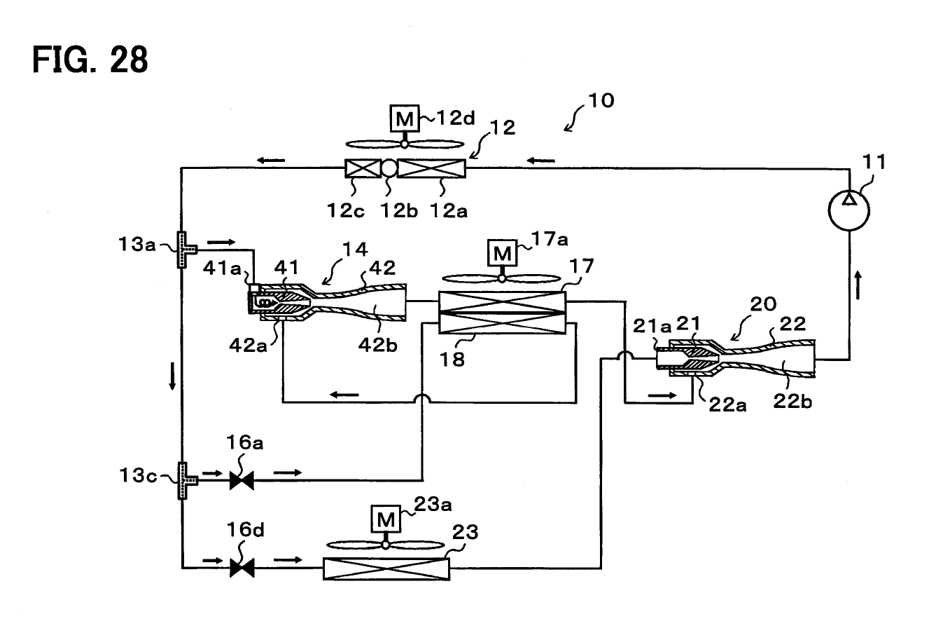

As shown in the entire configuration diagram of FIG. 28, in the twenty-second embodiment, the connection form of the downstream-side ejector 20 is changed from that of the ejector refrigeration cycle 10 of the fourteenth embodiment. Specifically, in this embodiment, like the twentieth embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. Such a cycle structure of this embodiment can also obtain the same effects as those of the fourteenth embodiment.

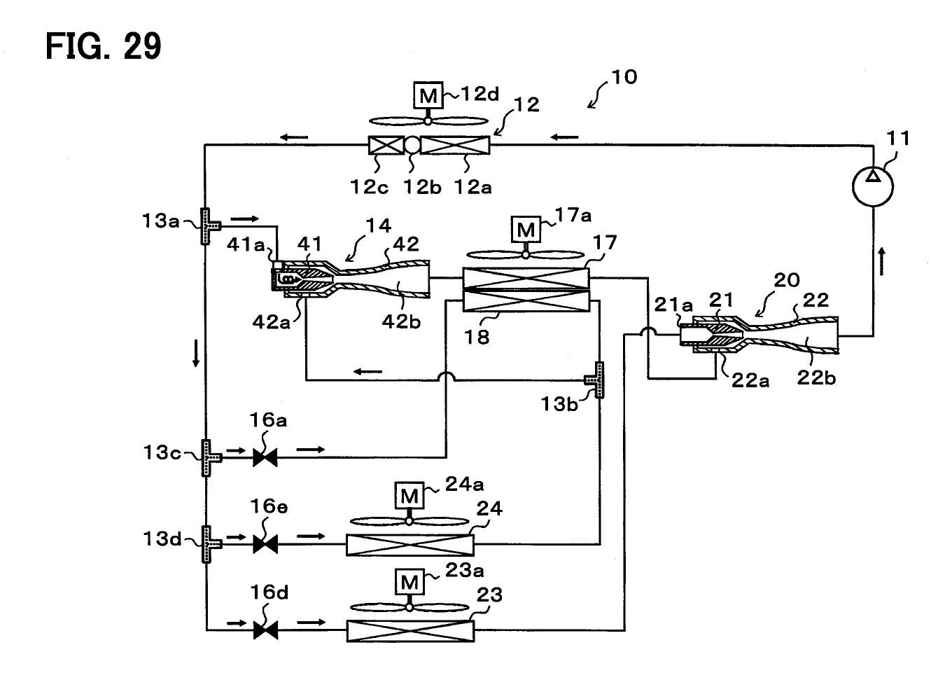

As shown in the entire configuration diagram of FIG. 29, in the twenty-third embodiment, the connection form of the downstream-side ejector 20 is changed from that of the ejector refrigeration cycle 10 of the fifteenth embodiment. Specifically, in this embodiment, like the twentieth embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. Such a cycle structure of this embodiment can also obtain the same effects as those of the fifteenth embodiment.

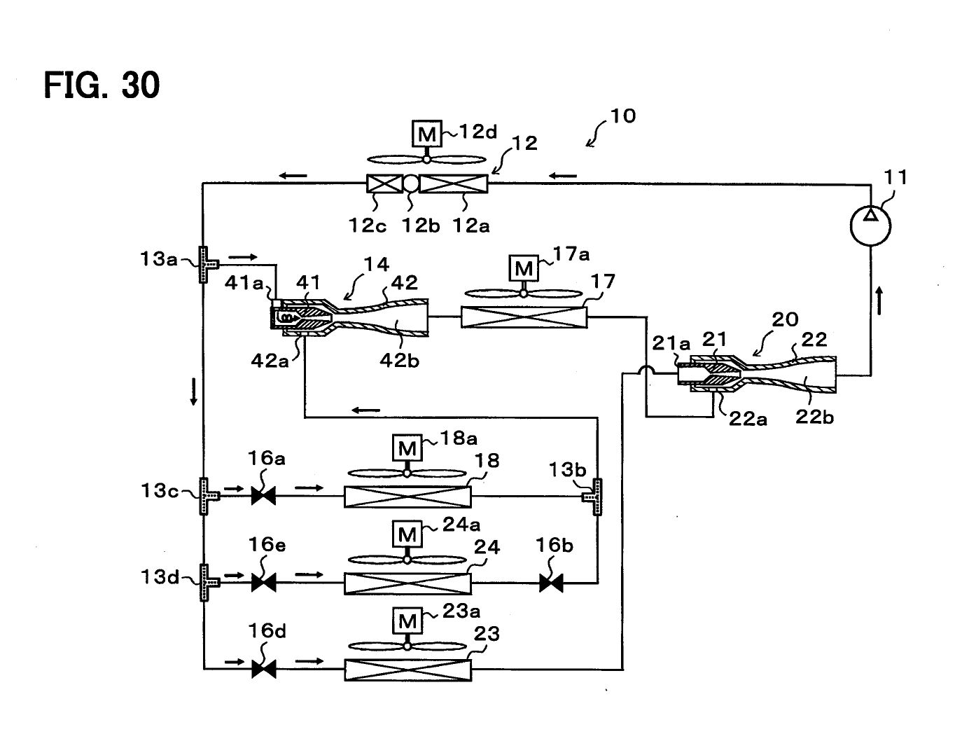

As shown in the entire configuration diagram of FIG. 30, in the twenty-fourth embodiment, the connection form of the downstream-side ejector 20 is changed from that of the ejector refrigeration cycle 10 of the sixteenth embodiment. Specifically, in this embodiment, like the twentieth embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. Such a cycle structure of this embodiment can also obtain the same effects as those of the sixteenth embodiment.

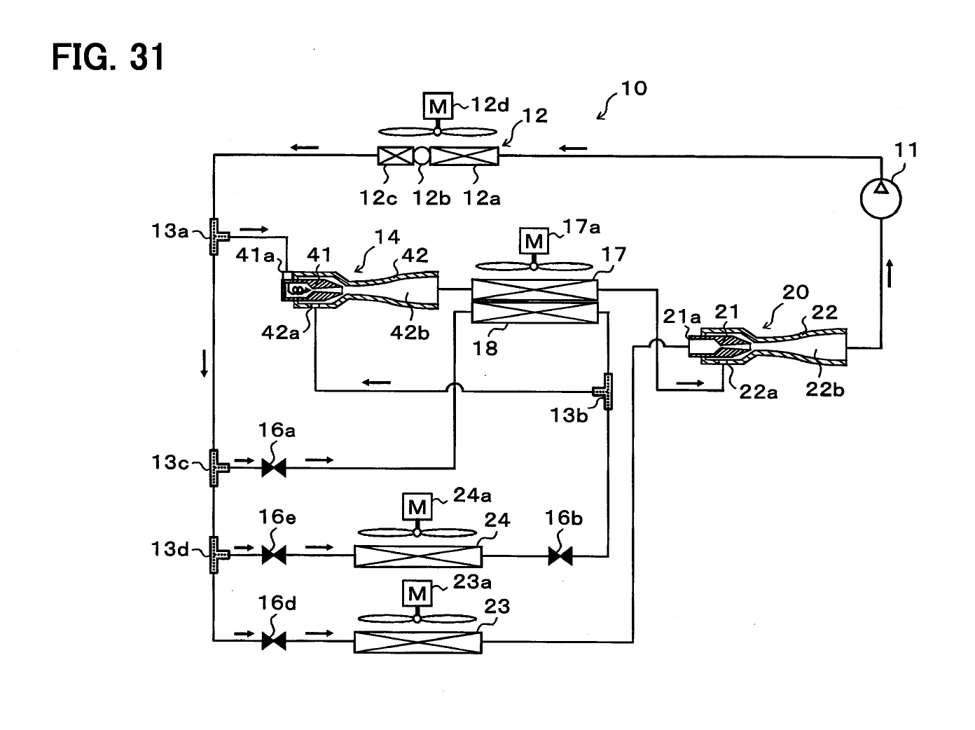

As shown in the entire configuration diagram of FIG. 31, in the twenty-fifth embodiment, the connection form of the downstream-side ejector 20 is changed from that of the ejector refrigeration cycle 10 of the seventeenth embodiment. Specifically, in this embodiment, like the twentieth embodiment, the refrigerant outlet of the first evaporator 17 is coupled to the side of the downstream-side refrigerant suction port 22a in the downstream-side ejector 20, while the refrigerant outlet of the third evaporator 23 is coupled to the side of the refrigerant inflow port 21a of the downstream-side nozzle 21 in the downstream-side ejector 20. Such a cycle structure of this embodiment can also obtain the same effects as those of the seventeenth embodiment.

### Twenty-Sixth Embodiment

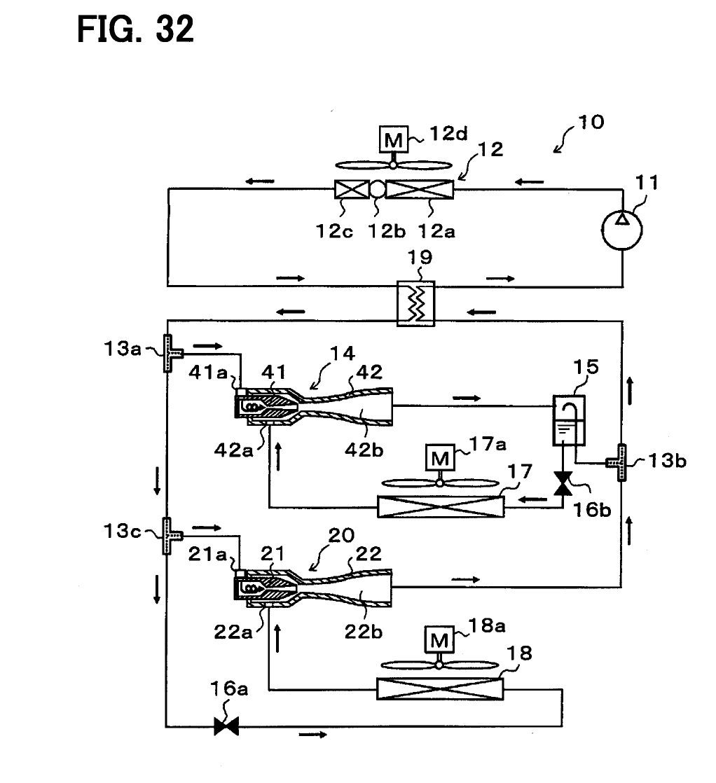

In this embodiment, as shown in the entire configuration diagram of FIG. 32, a cycle structure of an ejector refrigeration cycle 10 including the upstream-side ejector 14, the downstream-side ejector 20, and the internal heat exchanger 19 is changed, compared to the structure in the ninth embodiment.

Specifically, the ejector refrigeration cycle 10 of this embodiment includes a second upstream-side branch portion (upstream-side auxiliary branch portion) 13c that further branches the flow of the other refrigerant branched by the upstream-side branch portion 13a. Note that in this embodiment, the upstream-side branch portion 13a will be referred to as the “first upstream-side branch portion 13a” to clarify the explanation.

One of the refrigerant outflow ports of the second upstream-side branch portion 13c is coupled to the refrigerant inflow port 21a of the downstream-side nozzle 21 in the downstream-side ejector 20. The other refrigerant outflow port of the second upstream-side branch portion 13c is coupled to the downstream-side refrigerant suction port 22a of the downstream-side ejector 20 via the high-pressure side fixed throttle 16a and the second evaporator 18.

The gas-liquid separator 15 separates the refrigerant flowing out of the upstream-side diffuser 42b of the upstream-side ejector 14 into gas and liquid phase refrigerants. The gas-phase refrigerant outflow port of the gas-liquid separator 15 is coupled to one refrigerant inflow port of the merging portion 13b. The outlet side of the downstream-side diffuser 22b in the downstream-side ejector 20 is coupled to the other refrigerant inflow port of the merging portion 13b.

The inlet side of the low-pressure refrigerant passage in the internal heat exchanger 19 is coupled to the refrigerant outflow port of the merging portion 13b. Thus, the low-pressure refrigerant in the internal heat exchanger 19 of this embodiment circulates through the refrigerant flow path leading from the refrigerant outflow port side of the merging portion 13b to the suction port side of the compressor 11. The structures of other components of the ejector refrigeration cycle 10 except for the above points are the same as those of the ninth embodiment.

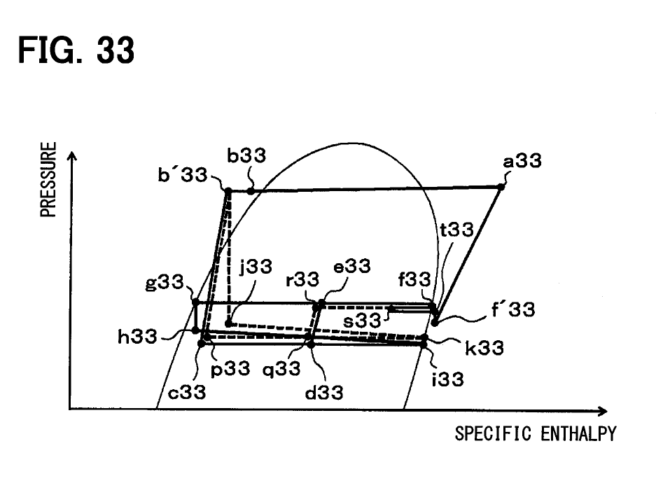

Next, the operation of the above-mentioned structure in this embodiment will be described with reference to the Mollier diagram of FIG. 33. When the ejector refrigeration cycle 10 of this embodiment is operated, the refrigerant discharged from the compressor 11 (as indicated at a point a33 in FIG. 33) is cooled and condensed by the radiator 12 (as indicated from the point a33 to a point b33 in FIG. 33) and then flows into the high-pressure refrigerant flow passage of the internal heat exchanger 19.

The high-pressure refrigerant flowing into the high-pressure refrigerant passage of the internal heat exchanger 19 exchanges heat with the low-pressure refrigerant circulating through the low-pressure refrigerant passage of the internal heat exchanger 19, decreasing its enthalpy (as indicated from the point b33 to a point b′33 in FIG. 33). The flow of refrigerant flowing out of the high-pressure refrigerant passage in the internal heat exchanger 19 is divided by the first upstream-side branch portion 13a.

One refrigerant branched by the first upstream-side branch portion 13a is isentropically decompressed by the upstream-side nozzle 41 of the upstream-side ejector 14 (as indicated from the point b′33 to a point c33 of FIG. 33). The refrigerant flowing out of the first evaporator 17 is drawn from the upstream-side refrigerant suction port 42a by the suction effect of the upstream-side injection refrigerant injected from the upstream-side nozzle 41 (as indicated from the point c33 to a point d33, and from a point i33 to the point d33 in FIG. 33).

The upstream-side injection refrigerant and an upstream-side suction refrigerant drawn from the upstream-side refrigerant suction port 42a are pressurized by the upstream-side diffuser 42b while being mixed together (as indicated from the point d33 to a point e33 in FIG. 33), and separated into gas and liquid phase refrigerants by the gas-liquid separator 15 (as indicated from the point e33 to a point f33, and from the point e33 to a point g33 in FIG. 33). The gas-phase refrigerant separated by the gas-liquid separator 15 flows into one of the refrigerant inflow ports of the merging portion 13b.

The liquid-phase refrigerant separated by the gas-liquid separator 15 is isentropically decompressed by the low-pressure side fixed throttle 16b (as indicated from the point g33 to a point h33 in FIG. 33) to flow into the first evaporator 17. The refrigerant flowing into the first evaporator 17 absorbs heat from the front-seat side ventilation air blown from the blower fan 17a to evaporate itself (as indicated from the point h33 to a point i33 in FIG. 33). In this way, the front-seat side ventilation air is cooled.

The flow of the other refrigerant branched by the first upstream-side branch portion 13a is further branched at the second upstream-side branch portion 13c. Note that in FIG. 33, to clarify the drawings, the changes in state of the refrigerant from the other refrigerant outflow port of the first upstream-side branch portion 13a to the other refrigerant inflow port of the merging portion 13b are illustrated by thick dashed lines.

One refrigerant branched by the second upstream-side branch portion 13c is isentropically decompressed by the downstream-side nozzle 21 of the downstream-side ejector 20 (as indicated from the point b′33 to a point p33 of FIG. 33). The refrigerant flowing out of the second evaporator 18 is drawn from the downstream-side refrigerant suction port 22a by the suction effect of the downstream-side injection refrigerant injected from the downstream-side nozzle 21 (as indicated from the point p33 to a point q33, and from a point k33 to the point q33 in FIG. 33).

The downstream-side injection refrigerant and a downstream-side suction refrigerant drawn from the downstream-side refrigerant suction port 22a are pressurized by the downstream-side diffuser 22b while being mixed together (as indicated from the point q33 to a point r33 in FIG. 33), and then flows into the other refrigerant inflow port of the merging portion 13b.

The other refrigerant branched by the second upstream-side branch portion 13c is isentropically decompressed by the high-stage side fixed throttle 16a (as indicated from the point b′33 to a point j33 in FIG. 33), and then flows into the second evaporator 18. The refrigerant flowing into the second evaporator 18 absorbs heat from the rear seat side ventilation air blown from the blower fan 18a to evaporate itself (as indicated from the point j33 to a point k33 in FIG. 33).

In this way, the rear-seat side ventilation air is cooled.

In the merging portion 13b, the flow of gas-phase refrigerant separated by the gas-liquid separator 15 and the flow of the gas-liquid two-phase refrigerant flowing out of the downstream-side diffuser 22b are merged together (as indicated from the point f33 to a point s33 and from a point r33 to the point s33 in FIG. 33). Then, the low-pressure refrigerant in the gas-liquid two-phase state having a relatively high dryness (as indicated at the point s33 in FIG. 33) flows toward the low-pressure refrigerant passage of the internal heat exchanger 19.

The low-pressure refrigerant flowing into the low-pressure refrigerant passage of the internal heat exchanger 19 exchanges heat with the high-pressure refrigerant circulating through the high-pressure refrigerant passage, increasing its enthalpy (as indicated from the point s33 to a point t33 in FIG. 33). Thus, the refrigerant flowing out of the low-pressure refrigerant passage of the internal heat exchanger 19 is brought into the gas-phase state having a relatively low superheat degree. The refrigerant flowing out of the low-pressure refrigerant passage in the internal heat exchanger 19 is drawn into the compressor 11 and compressed again by the compressor 11 (as indicated from the point f′33 to the point a33 of FIG. 33).

Therefore, the ejector refrigeration cycle 10 of this embodiment operates in the manner described above and thus can cool the front-seat side ventilation air and the rear-seat side ventilation air, thereby improving the COP of the cycle by the pressurizing effect of the upstream-side diffuser 42b in the upstream-side ejector 14 as well as the downstream-side diffuser 22b in the downstream-side ejector 20.

Further, the ejector refrigeration cycle 10 of this embodiment has the structure that decompresses the refrigerant flowing into the first evaporator 17, by the upstream-side nozzle 41 in the upstream-side ejector 14, while decompressing the refrigerant flowing into the second evaporator 18, by the high-stage side fixed throttle 16a. Thus, the refrigerant evaporation temperature at the first evaporator 17 can be easily set substantially equal to that at the second evaporator 18. Likewise, the flow rate of refrigerant flowing into the first evaporator 17 can be easily set substantially equal to that into the second evaporator 18.

As a result, the cooling capacity of the first evaporator 17 can be effectively made close to that of the second evaporator 18. In the ejector refrigeration cycle 10 of this embodiment, the merging portion 13b is adapted to merge the flow of gas-phase refrigerant separated by the gas-liquid separator 15 with the flow of gas-liquid two-phase refrigerant flowing out of the downstream-side diffuser 22b, thereby allowing the low-pressure refrigerant in the gas-liquid two-phase stage to flow into the low-pressure refrigerant passage in the internal heat exchanger 19.

The superheat degrees of low-pressure refrigerant flowing out of the low-pressure refrigerant passage of the internal heat exchanger 19 and sucked into the compressor 11 can be prevented from increasing unnecessarily. Therefore, this embodiment can prevent the refrigerant discharged from the compressor 11 from excessively being at high temperature and from adversely affecting the durability life of the compressor 11.

Note that this embodiment has described the example in which the low-pressure refrigerant flowing into the internal heat exchanger 19 circulates through the refrigerant flow path leading from the refrigerant outflow port side of the merging portion 13b to the suction port side of the compressor 11. However, the low-pressure refrigerant entering the internal heat exchanger 19 can obtain the same protection effect for the compressor 11 even if it circulates through the refrigerant flow path leading from the outlet side of the downstream-side pressurizing portion 22b to the inlet side of the merging portion 13b.

That is, the internal heat exchanger 19 in this embodiment is adapted to exchange heat between the high-pressure refrigerant and the low-pressure refrigerant. The high-pressure refrigerant circulates through the refrigerant flow path from the refrigerant outlet side of the radiator 12 to the inlet side of the first upstream-side branch portion 13a. The low-pressure refrigerant circulates through the refrigerant flow path from the outlet side of the downstream-side diffuser 22b to the suction port side of the compressor 11. This embodiment can prevent the superheat degree of the low-pressure refrigerant sucked into the compressor 11 from increasing unnecessarily.

Although in the embodiments, the first upstream-side branch portion 13a and the second upstream-side branch portion 13b are configured by a three-way joint respectively, the first upstream-side branch portion 13a and the second upstream-side branch portion 13b may be integrally formed, for example, by a four-way joint.

### Other Embodiments

The present disclosure is not limited to the above embodiments, and various modifications and changes can be made to those embodiments in the following way without departing from the scope of the present disclosure. The means disclosed in the above respective embodiments may be appropriately combined within the feasible range.

(1) In the above-mentioned embodiments according to the present disclosure, the ejector refrigeration cycle 10 is applied to a vehicle air conditioner of a dual air conditioner type, the first evaporator 17 is used to cool the front-seat side ventilation air, and the second evaporator 18 is used to cool the rear-seat side ventilation air by way of example. However, the applications of the first and second evaporators 17 and 18 are not limited to such fluids to be cooled.

For example, the first evaporator 17 may be used to cool the rear-seat side ventilation air, and the second evaporator 18 may be used to cool the front-seat side ventilation air.

Although in the above-mentioned embodiments, the third evaporator 23 and the fourth evaporator 24 are used to supplementarily cool the front-seat side or rear-seat side ventilation air, the third evaporator 23 and the fourth evaporator 24 may be used to cool another fluid to be cooled. For example, the third evaporator 23 or the fourth evaporator 24 may be used to cool ventilation air for a refrigerator that is blown to and circulates through a vehicle refrigerator (cool box) disposed in the vehicle compartment.

The application of the ejector refrigeration cycles 10 described in the above embodiments is not limited to the vehicle air conditioner. For example, the ejector refrigeration cycle may be applied to a stationary air conditioner, a freezer refrigerator, and the like.

(2) In the above embodiments, a sub-cool heat exchanger is used as the radiator 12 by way of example. Alternatively, a normal radiator consisting of only the condensing portion 12a may be employed. Further, together with the normal radiator, a liquid reservoir (receiver) may be used that separates the refrigerant having its heat dissipated at the radiator into gas and liquid phases and stores excessive liquid-phase refrigerant therein.

In the above-mentioned embodiments, various components, including the nozzles 41, 21, and the bodies 42 and 22 of the upstream-side ejector 14 and the downstream-side ejector 20, are formed of metal by way of example. As long as the respective components can exhibit their own functions, materials for these components are not limited. Thus, these components may be formed of resin and the like.

In the above-mentioned embodiments, the upstream-side ejector 14 and the gas-liquid separator 15 may be separately configured by way of example. Alternatively, the gas-liquid separator 15 may be integrated with the outlet side of the upstream-side diffuser 42b in the upstream-side ejector 14, and the downstream-side gas-liquid separator 15a may be integrated with the outlet side of the downstream-side diffuser 22b in the downstream-side ejector 20.

In the above-mentioned embodiments, the upstream-side ejector 14 and the downstream-side ejector 20 employ the fixed nozzle in which a refrigerant passage area of the minimum passage area portion does not change by way of example. However, the upstream-side ejector 14 and the downstream-side ejector 20 may employ a variable nozzle in which the refrigerant passage area of the minimum passage area portion is variable.

Such a variable nozzle may be configured by disposing a needle-shaped or conically-shaped valve body in a passage of the variable nozzle, the valve body being designed to be displaced by an electric actuator or the like to adjust the refrigerant passage area.

In the above embodiments, the fixed throttle is employed by way of example as the high-pressure side fixed throttle 16a, the low-pressure side fixed throttle 16b, and the like. It is obvious that a variable throttle mechanism, such as a thermal expansion valve or an electric expansion valve, may be employed.

(3) In the above second embodiment or the like, the ejector refrigeration cycle 10 including the internal heat exchanger 19 has been explained. It is obvious that the internal heat exchanger 19 may be added to the ejector refrigeration cycle 10 described in the tenth to twenty-fifth embodiments.
(4) Although in the above embodiment, R134a, R1234yf, etc., can be employed as the refrigerant, the refrigerant is not limited thereto. For example, the refrigerants, such as R600a, R410A, R404A, R32, R1234yfxf, or R407C can be used. Alternatively, a mixed refrigerant including a mixture of a plurality of kinds of refrigerants among these refrigerants may be employed.

1-12. (canceled)

13. An ejector refrigeration cycle comprising:
a compressor adapted to compress and discharge a refrigerant;
a radiator that dissipates heat from the refrigerant discharged from the compressor;
an upstream-side branch portion that branches a flow of the refrigerant flowing out of the radiator;
an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the upstream-side branch portion, the upstream-side ejector being adapted to cause an upstream-side pressurizing portion to pressurize a mixed refrigerant of the upstream-side injection refrigerant and the refrigerant drawn from the upstream-side refrigerant suction port;
a low-pressure side gas-liquid separator that separates the refrigerant flowing out of the upstream-side ejector into gas and liquid phase refrigerants, to allow the separated gas-phase refrigerant to flow to a suction port side of the compressor;
a first evaporator that evaporates the liquid-phase refrigerant separated by the low-pressure side gas-liquid separator;
a decompression device that decompresses the other refrigerant branched by the upstream-side branch portion; and
a second evaporator that evaporates the refrigerant decompressed by the decompression device, wherein
the upstream-side refrigerant suction port of the upstream-side ejector is coupled to both of a refrigerant outlet side of the first evaporator and a refrigerant outlet side of the second evaporator.

14. An ejector refrigeration cycle comprising:
a compressor adapted to compress and discharge a refrigerant;
a radiator that dissipates heat from the refrigerant discharged from the compressor;
an upstream-side branch portion that branches a flow of the refrigerant flowing out of the radiator;
an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the upstream-side branch portion, the upstream-side ejector being adapted to cause an upstream-side pressurizing portion to pressurize a mixed refrigerant including the upstream-side injection refrigerant and the refrigerant drawn from the upstream-side refrigerant suction port;
a downstream-side branch portion that branches a flow of the refrigerant flowing out of the upstream-side ejector;
a downstream-side ejector that draws a refrigerant from a downstream-side refrigerant suction port by a suction effect of a downstream-side injection refrigerant injected at high velocity from a downstream-side nozzle adapted to decompress one of the refrigerants branched by the downstream-side branch portion; the downstream-side ejector being adapted to cause a downstream-side pressurizing portion to pressurize a mixed refrigerant of the downstream-side injection refrigerant and the refrigerant drawn from the downstream-side refrigerant suction port;
a first evaporator that evaporates the other refrigerant branched by the downstream-side branch portion;
a decompression device that decompresses the other refrigerant branched by the upstream-side branch portion; and
a second evaporator that evaporates the refrigerant decompressed by the decompression device, wherein
the upstream-side refrigerant suction port is coupled to a refrigerant outlet side of the first evaporator, and
the downstream-side refrigerant suction port is coupled to a refrigerant outlet side of the second evaporator.

15. The ejector refrigeration cycle according to claim 14, wherein
the downstream-side branch portion is configured by a low-pressure side gas-liquid separator that separates the refrigerant flowing out of the upstream-side ejector, into gas and liquid phase refrigerants.

16. The ejector refrigeration cycle according to claim 14, wherein
the decompression device decompresses a part of the other refrigerant branched by the upstream-side branch portion, the ejector refrigeration cycle further comprising:
an auxiliary decompression device that decompresses another part of the other refrigerant branched by the upstream-side branch portion; and
a third evaporator that evaporates the refrigerant decompressed by the auxiliary decompression device, wherein
a refrigerant outlet side of the third evaporator is coupled to one of the upstream-side refrigerant suction port and the downstream-side refrigerant suction port.

17. An ejector refrigeration cycle comprising:
a compressor adapted to compress and discharge a refrigerant;
a radiator that dissipates heat from the refrigerant discharged from the compressor;
a first upstream-side branch portion that branches a flow of the refrigerant flowing out of the radiator;
an upstream-side ejector that draws a refrigerant from an upstream-side refrigerant suction port by a suction effect of an upstream-side injection refrigerant injected at high velocity from an upstream-side nozzle adapted to decompress one of the refrigerants branched by the first upstream-side branch portion, the upstream-side ejector being adapted to cause an upstream-side pressurizing portion to pressurize a mixed refrigerant of the upstream-side injection refrigerant and the refrigerant drawn from the upstream-side refrigerant suction port;
a gas-liquid separator that separates the refrigerant flowing out of the upstream-side ejector into gas and liquid phase refrigerants, to allow the separated gas-phase refrigerant to flow out to a suction port side of the compressor;
a first evaporator that evaporates the liquid-phase refrigerant separated by the gas-liquid separator to allow the refrigerant to flow out toward the upstream-side refrigerant suction port;
a second upstream-side branch portion that further branches a flow of the other refrigerant branched by the first upstream-side branch portion;
a downstream-side ejector that draws a refrigerant from a downstream-side refrigerant suction port by a suction effect of a downstream-side injection refrigerant injected at high velocity from a downstream-side nozzle adapted to decompress one of the refrigerants branched by the second upstream-side branch portion, the downstream-side ejector being adapted to cause a downstream-side pressurizing portion to pressurize a mixed refrigerant of the downstream-side injection refrigerant and the refrigerant drawn from the downstream-side refrigerant suction port;
a decompression device that decompresses the other refrigerant branched by the second upstream-side branch portion;
a second evaporator that evaporates the refrigerant decompressed by the decompression device to allow the refrigerant to flow out toward the downstream-side refrigerant suction port;
a merging portion that merges a flow of the gas-phase refrigerant separated by the low-pressure side gas-liquid separator with a flow of the refrigerant flowing out of the downstream-side pressurizing portion to allow the merged refrigerant to flow out toward a suction side of the compressor; and
an internal heat exchanger that exchanges heat between a high-pressure refrigerant circulating through a refrigerant flow path leading from a refrigerant outlet side of the radiator to an inlet side of the first upstream-side branch portion and a low-pressure refrigerant circulating through a refrigerant flow path leading from an outlet side of downstream-side pressurizing portion to a suction port side of the compressor.

18. The ejector refrigeration cycle according to claim 17, wherein the low-pressure refrigerant is a refrigerant that circulates through a refrigerant flow path leading from a refrigerant outflow side of the merging portion to a suction port side of the compressor.

19. The ejector refrigeration cycle according to claim 17, wherein
the low-pressure refrigerant is a refrigerant that circulates through a refrigerant flow path leading from an outlet side of the downstream-side pressurizing portion to an inlet side of the merging portion.
